(19) United States
(12) Patent Application Publication
(10) Pub. No.: US 2026/0201232 A1
(43) Pub. Date: Jul. 16, 2026

(54) RADIATION CURABLE PHASE CHANGE MATERIAL SOLUTIONS AND SHAPE STABLE THERMOSET PHASE CHANGE MATERIAL GELS FORMED THEREFROM

(71) Applicant: MICROTEK HOLDINGS, INC., Dayton, OH (US)

(72) Inventors: Richard M. FORMATO, Grafton, MA (US); Ryan W. HAMELIN, Fitchburg, MA (US); Jacob Grove, Rochdale, MA (US)

(73) Assignee: MICROTEK HOLDINGS, INC., Dayton, OH (US)

(21) Appl. No.: 19/416,202

(22) Filed: Dec. 11, 2025

Related U.S. Application Data
(60) Provisional application No. 63/734,052, filed on Dec. 14, 2024.

(51) Int. Cl. C09K 5/06; C08K 5/01; C08K 5/101; C08L 9/00; C08L 9/06; F25D 3/08

(52) U.S. Cl. CPC C09K 5/066; C08K 5/01; C08K 5/101; C08L 9/00; C08L 9/06; F25D 3/08; C08L 2205/025; C08L 2205/03; F25D 2303/085

(57) ABSTRACT

Thermoset thermal energy gels having a radiation cured polymeric network are formed from a hydrophobic phase change material (PCM); (a) 1% wt/wt to 15% wt/wt of a polybutadiene based rubber polymer that is soluble in the PCM and has (i) a pendant 1,2 vinyl content of at least 0.5% wt/wt thereof or (ii) a 1,4 cis content of at least 9.0% wt/wt; or (iii) a combination of 1,2 vinyl content plus a 1,4 cis content of at least 45% wt/wt; or (b) 1% wt/wt to 15% wt/wt of a polyisoprene based rubber polymer that is soluble in the PCM and has (i) a combination of 1,2 Add plus 3,4 Add content of at least 0.5% wt/wt thereof or (ii) a combination of 1,4 cis content plus a 1,4 trans content of at least 40% wt/wt; and 0.01% wt/wt to 0.50% wt/wt of a photoinitiator soluble in the PCM.

### RELATED APPLICATIONS

This application claims the benefit of U.S. Provisional Application No. 63/734,052, filed Dec. 14, 2024, the entirety of which is incorporated herein by reference.

### TECHNICAL FIELD

The present application relates to radiation curable phase change material (PCM) solutions and shape stable thermoset phase change material gels formed therefrom after exposure to radiation, more particularly, to radiation curable phase change material solutions and thermoset thermal energy gels comprising a hydrophobic PCM, a rubber polymer, a photoinitiator, optionally, a thickener resin, without the need for a crosslinker.

### BACKGROUND

Phase change materials (PCMs) have been utilized as thermal energy storage systems for decades due to their ability to store and release energy in the form of heat during a phase transition, most commonly from the solid to liquid states. PCMs exist in many forms including organic, inorganic, eutectics, and solid-solid. With this wide variety, a range of (phase change) temperatures for different applications can be achieved. It is important to have a PCM phase change temperature in a workable range for the application in order to get the full charge of energy out of (or into) the system. These storage systems can be implemented in many different applications such as bedding, textiles, electronics, bio-tech, and pharmaceutical.

A commonly known application of energy storage is in the form of cold pack therapy. Cold packs are generally water based formulations that once active, keep their surroundings cold for a specified amount of time. They are commonly used as first aid relief, and food and beverage controlled refrigeration. Water is one of the best known PCMs due to its high latent heat value of 334 J/g, but water also has disadvantages. Water melts around 0° C., however, it can be super cooled to temperatures on the order of −40° C. Most commercial freezers only reach temperatures in the −23° C. to −15° C. range, which presents a problem for a water based formulation that requires freeze temperatures lower than that to charge the PCM completely.

For temperatures common in packaging applications (refrigerated being 2° C. to 8° C., controlled room temperature being 15° C. to 25° C., frozen being ≤0° C. and typically ≤−20° C.) a number of organic and inorganic PCMs have been developed, with organic PCMs, such as n-alkanes being a common choice for refrigerated and controlled room temperature. Since these PCMs are designed to be changeable to or from a liquid state, such PCMs are typically encased within some form of closed container. An example of one common type of closed container is a flexible pouch, and an example of another common type of closed container is a rigid bottle. One problem that has been encountered, particularly with organic PCMs (n-alkanes, specifically), is that, because these PCMs have very low surface tension, if there is a defect, such as a hole, in the container holding the phase-change material, the phase-change material tends to pass very easily through the defect and subsequently flows near or onto the temperature-sensitive product. As can readily be appreciated, the passage of the phase-change material through such a defect is undesirable. The gel of the present invention is designed to remedy this issue.

Like the gel of the present invention, there are other commercially available organic PCM Gels available, for example from Cold Chain Technologies, which claims to have the durability of a (blow molded) rigid bottle, with the flexibility of gel pack (see, for example U.S. Pat. No. 11,739,244 B2 to Formato et al). While this gelled PCM product does provide a leakproof solution that has advantages over rigid blow molded bottles, the technology does have drawbacks, including but not limited to:
a) utilizes a physical gel that works with n-alkane PCMs only;
b) the physical gel has high syneresis (up to 10% wt loss over 100 F/T cycles);
c) the gelling agent/PCM is a non-homogenous mixture that must be dispensed directly into the end use (flexible film) packaging, such that it cannot be pre-mixed, stored, and used at a later time;
d) packaging size limitations due to the nature of the manufacturing process (e.g. very thin, small pouches, for example less than 2″L×2″W×0.25″ thick cell size are not possible);
e) formation of the physical gel requires the application of heat, followed by cool down to room temperature; and
f) the nature of the gelled PCM (non-homogeneous mixture) precludes it from being made on a vertical sachet and/or vertical form fill or seal (VFFS) machine.
   These factors make for both restrictions in end use applications as well as a complex manufacturing process.

As such, a need exists for lower cost, low solids loading, organic PCM gels that work with PCMs other than n-alkanes (e.g. fatty acid methyl esters, fatty acids, fatty alcohols), which utilize a more friendly manufacturing process (can be made on a sachet or VFFS machine), which does not require the pre-cured mixture to be immediately dispensed into the flexible film packaging and/or can be utilized for any size packaging, while simultaneously having excellent syneresis (e.g., <1% wt at 500 cycles), and good creep resistance (no flow at or above +50° C.), in typical end-use conditions.

As taught in co-owned U.S. application Ser. No. 17/187,033, shape stable thermoset phase change material gels were created that include a hydrophobic phase change material, a radiation curable polybutadiene urethane acrylate oligomer soluble in the hydrophobic phase change material, a photoinitiator soluble in the hydrophobic phase change material, and a monofunctional or di-functional crosslinker soluble in the hydrophobic phase change material. While this gel resolves most of the issues noted above, the radiation curable polybutadiene urethane acrylate oligomer is an expensive material, which precludes use in some packaging applications, the typical solids loadings are about 15% wt, and creep resistance (no-flow at or above +50° C.) has been problematic in end use.

There is always a need for new and improved thermal energy storage systems utilizing PCMs that are creep resistant above room temperature, maintain the weight of the PCM at higher temperatures, are syneresis resistant, are easy to manufacture, are adaptable to existing manufacturing methods and machinery, meet other adopted product specifications, have fewer ingredients, and can meet costs and supply chain demands.

### SUMMARY

In one aspect, thermoset thermal energy gels having a radiation cured polymeric network are formed from a hydrophobic phase change material (PCM); (a) 1% wt/wt to 15% wt/wt of a polybutadiene based rubber polymer that is soluble in the PCM and has (i) a pendant 1,2 vinyl content of at least 0.5% wt/wt thereof or (ii) a 1,4 cis content of at least 9.0% wt/wt; or (iii) a combination of 1,2 vinyl content plus a 1,4 cis content of at least 45% wt/wt; or (b) 1% wt/wt to 15% wt/wt of a polyisoprene based rubber polymer that is soluble in the PCM and has (i) a combination of 1,2 Add plus 3,4 Add content of at least 0.5% wt/wt thereof or (ii) a combination of 1,4 cis content plus a 1,4 trans content of at least 40% wt/wt; and 0.01% wt/wt to 0.50% wt/wt of a photoinitiator soluble in the PCM. In some embodiments, the polybutadiene based rubber polymer or the polyisoprene based rubber polymer is present as 1% to 10% wt/wt of the thermoset thermal energy gel. In some embodiments, the rubber polymer has a dissolution point, in the hydrophobic phase change material, of equal to or less than 100° C., equal to or less than 75° C., or in a range of 30° C. to 40° C.

In some embodiments, the polybutadiene based rubber polymer is a polybutadiene rubber, a styrene butadiene rubber, or a styrene butadiene styrene rubber. The polybutadiene based rubber polymer can be (a) a high vinyl 1,2-polybutadiene atactic linear polymer with a vinyl content of 77%, with a Tg of −31° C. and a Mooney viscosity (ML (1+4), 100° C.) of 70, (b) a high vinyl 1,2-polybutadiene polymer that is syndiotactic, with a Mw of 100,000 g/mol a melting point of 71° C., and a 1,2-polybutadiene vinyl content of 90% wt/wt, or (c) a random copolymer high vinyl solution polymerized styrene butadiene rubber (S-SBR), with a styrene content of 15% to 21% wt/wt, a 1,2-vinyl content of 48% to 68% with respect to polybutadiene, and a Mooney viscosity between 58 and 75.

In some embodiments, the polyisoprene based rubber polymer is a polyisoprene rubber, a copolymer of polyisoprene and polybutadiene rubber, or a styrene isoprene styrene rubber.

In some embodiments, the rubber polymer is a syndiotactic butadiene rubber. In some embodiments, the rubber polymer is a 1,4 cis butadiene rubber having a 1,4 cis content of between 35% to 40% wt/wt. In other embodiments, the rubber polymer is a 1,4 cis butadiene rubber having a 1,4 cis content of at least 90% wt/wt.

In all aspects, the hydrophobic phase change material is selected from the group consisting of an n-alkane, a fatty acid methyl ester, a fatty alcohol, a fatty acid, and mixtures thereof. The n-alkane can be saturated and has carbon atoms within the range of C₁₀-C₃₀ and the fatty acid methyl ester has carbon atoms within the range of C₁₂-C₁₆.

In all aspects, the photoinitiator comprises phosphine oxide.

In all aspects, the thermoset thermal energy gel can include a hydrogenated styrenic block copolymer as a secondary resin as 0.5% to 15% wt/wt of the gel. The hydrogenated styrenic block copolymer is fully hydrogenated and is selected from the group consisting of a styrene-ethylene-propylene (SEP) polymer, a styrene-ethylene-propylene-styrene (SEPS) polymer, a styrene-ethylene-ethylene-propylene-styrene (SEEPS) polymer, a styrene-ethylene-butylene-styrene (SEBS) polymer, a SEBS with an enhanced rubber segment (ERS), a styrene-ethylene butylene/styrene-styrene (S-EB/S-S) polymer, and combinations thereof. In one embodiment, the hydrogenated styrenic block copolymer is a diblock SEP, which can have styrene as 25% to 40% wt/wt thereof and is 100% diblock in structure. In one embodiment, the hydrogenated styrenic block copolymer is a diblock or triblock copolymer.

In a secondary aspect, radiation curable phase change solutions are disclosed that include the above described and further herein described formulations.

In another aspect, cold packs are disclosed that have a container sealingly enclosing one of the thermoset gels presented herein. The container con be a rigid container that retains a preselected shape and configuration or a flexible container that is conformable to a surface against which the flexible container is seated.

### BRIEF DESCRIPTION OF THE DRAWINGS

FIG. 1 is a reaction scheme theorized for high 1,2 vinyl polybutadiene rubber polymers.

FIG. 2 is a reaction scheme theorized for (medium/high) 1,4,cis polybutadiene rubber polymers.

FIG. 3 is a photograph of a cured PCM gel that has a decreasing concentration of polybutadiene rubber polymer (left to right), showing the effective minimum gel concentration.

FIG. 4 is a chart of polybutadiene rubber polymers indicating their respective results for an initial creep test and a 24 cycle syneresis test of 10% wt/wt polymer in PCM6 at room temperature, at 70° C., and while cooling from 70° C. to room temperature.

FIG. 5 is a chart of the same polyisoprene rubber polymers from FIG. 4 indicating their respective results of pumpability and a flow evaluation at 10% wt/wt polymer in PCM6 at room temperature, at 70° C., and while cooling from 70° C. to room temperature. FIG. 6 is a sequence of photographs from a syneresis experiment.

FIG. 7 is a chart of test data for high efficiency polymeric thickeners.

FIG. 8 is a summary of the overall test results for the third generation product development. ShiftGen3 is a 6% wt/wt RB810 (vinyl), 6% wt G1702, 0.2% wt/wt LTD or BAPO, and 88% wt/wt n-alkane PCM, and ShiftGen 2 is a 7.5% wt/wt BR-641 E (polybutadiene urethane acrylate) by Bomar (formerly Dymax Oligomers & Coatings), 6.5% wt/wt G1701, 0.5% wt/wt BAPO, and 85% wt/wt n-alkane PCM.

FIG. 9 is a chart of preliminary creep test results for the third generation product.

FIG. 10 is a chart of additional creep test results for the third generation product.

FIG. 11A is a chart of creep and syneresis data corresponding to working example 3 at 500 cycles.

FIG. 11B is a chart of creep and syneresis data corresponding to working example 3 at 300 cycles.

FIG. 12 is a chart of creep and syneresis data corresponding to working example 4.

FIG. 13 is a chart of syneresis data corresponding to working example 5.

FIG. 14 is a chart of additional syneresis data corresponding to working example 6.

FIG. 15 is a chart of creep data corresponding to working example 7.

FIG. 16 is a chart of syneresis data corresponding to working example 8.

FIG. 17 is a chart of syneresis and creep data corresponding to working example 9.

FIG. 18 is a chart of creep data corresponding to working examples 10.

FIG. 19 is a chart of syneresis data corresponding to working example 11.

### DETAILED DESCRIPTION

The following detailed description will illustrate the general principles of the invention, examples of which are additionally illustrated in the working and comparative examples.

As used herein, “gel” means a coherent mass consisting of a liquid in which particles too small to be seen in an ordinary optical microscope are either dispersed or arranged in a fine network throughout the mass. A gel may be notably elastic and jellylike (as gelatin or fruit jelly), or quite solid and rigid (as silica gel, a material that looks like coarse white sand and is used as a dehumidifier). Gels are colloids (aggregates of fine particles, as described above, dispersed in a continuous medium) in which the liquid medium is immobilized in the fine network by surface tension effects.

As used herein “soluble” means that a substance can be dissolved in another, typically called the solvent, by physical rather than chemical means. In this application, the hydrophobic phase change material is the solvent, and the dissolution preferably occurs at ambient or room temperature. Room temperature is typically 25° C., but can vary by +/−5° C. When the two substances being mixed are both in the liquid phase, the liquids are “miscible” if the solute is soluble at all proportions in the hydrophobic phase change material.

As used herein “shape stable” means a gel that supports its own weight, does not leak PCM at room temperature, retains its shape upon exposure to 50° C. for 1 hour (ideally overnight), and after 24 freeze/thaw cycles has minimal liquid PCM weight loss (e.g., ideally less than 1% wt/wt).

Radiation curing equipment is generally divided into two types: Broad Spectrum and Light Emitting Diode (LED). Both of these are further comprised of flood cure and conveyor cure options. Radiation utilized can be ultra-violet (UV) radiation, visible (VIS) radiation or electron beam (EB) radiation. The UV spectrum is typically broken down into three ranges, specifically UVA (315 to 400 nm), UVB (280 to 315 nm) and UVC (100 to 280 nm). LEDs can use both UV (100 to 400 nm) and Visible (400 to 700 nm) radiation to effect cure, and typically have the majority of their intensity centered around a specific wavelength (e.g., 365 nm, 385 nm, 405 nm). Shorter wavelengths are used to promote surface cure, while longer wavelengths are used to promote depth of cure. For example, some commercially available bulbs focus energy in the shortwave, longwave and visible regions. For the purposes of making the thermoset thermal energy gel, both standard mercury arc UV “D” bulbs and LED bulbs were used to cure PCM material solutions in both flood cure and conveyor cure setups, without any obvious change in gel properties.

A radiation curable phase change material solution has been developed that produces a shape stable, thermoset PCM gel upon exposure to radiation, which solves the problems with existing PCM gels and meets the needs of the industry. The exposure time to radiation is in a range of 1 second to 15 seconds (e.g., intensity of 170 mW/cm² with corresponding dose of 170 mJ/cm² to 2550 mJ/cm²), more preferably 1 second to 8 seconds (e.g., dose up to 1360 mJ/cm²). In one embodiment, up to 3 inches of the solution cured in just 1 second. No matter what format or curing equipment was utilized, flood cure or conveyor cure, a minimum surface intensity of 100 mW/cm² for a duration between 1 to 2 seconds (dose of 100 to 200 mJ/cm²) was found to cure the phase change material solution.

The radiation curable phase change solution has a hydrophobic phase change material, a radiation curable rubber polymer that is soluble in the hydrophobic phase change material and present as 1% wt/wt to 15% wt/wt of the gel, a photoinitiator soluble in the hydrophobic phase change material and present as 0.02% wt/wt to 1% wt/wt of the gel. The balance of the gel is the hydrophobic phase change material. In another embodiment, the radiation curable rubber polymer is present in a range of 1% wt/wt to 10% wt/wt of the gel and the photoinitiator is present in a range of 0.2% wt/wt to 0.5% wt/wt of the gel.

The radiation curable phase change solution and resulting gel is free of or substantially free of a crosslinker. As determined experimentally, when the radiation curable rubber polymer is a butadiene rubber (BR) based polymer no crosslinker is needed, the amount is 0% wt/wt. For those based on isoprene rubber (IR), a crosslinker can be present in a range of 0.01% wt/wt to 10% wt/wt thereof, more preferably in a range of 0.01% wt/wt to 5% wt/wt. For the IR based gels, vinyl caprolactam (VCAP) was tested as a crosslinker and found ineffective, e.g., no fully cured gels formed. EBECRYL® 113 is a low odor aliphatic monofunctional diluting acrylate available from Allnex. This crosslinker was effective in the IR based gel. Gels comprising 15% wt/wt IR polymer, 0.5% wt/wt photoinitiator, 1% wt/wt EBECRYL® 113 crosslinker, balance PCM were fully cured by UV light. Likewise, gels comprising 10% wt/wt IR, 0.2% wt/wt photoinitiator, 1% wt/wt EBECRYL® 113, balance PCM were fully cured by UV light.

The radiation curable phase change solution contains between 0% to 20% wt/wt solids, preferably less than 10% wt/wt solids, and more preferably less than 5% wt/wt solids. It is always desirable to have the greatest possible amount of the PCM present for maximum thermal control in the end product, i.e., a lower % wt/wt solids. Increasing the amount of the PCM while decreasing the amount of the resin will decrease the percent solids in the formulation. When heated to a temperature equal to or greater than 50° C., but typically at or less than 80° C. or even less than 70° C., the solution has a viscosity equal to or less than 2000 cP, more preferably equal to or less than 500 cP, thereby providing a solution that can flow at or proximate to room temperature. In one embodiment, the solution has a viscosity equal to or less than 500 cP at 22° C. Flow is desired so that the solution can be pumped post-mixing into packaging machines, such as a sachet filling machine or a matrix vertical form fill seal (VFFS) machine.

The cured gel has a latent heat that is equal to or greater than 85% of the latent heat of the PCM present therein, more preferably equal to or greater than 90% of the latent heat of the PCM present. It is preferred that the cured gel have no visual color change as seen with the naked eye when subjected to 70° C. for 24 hours, and even more preferably when subjected to 40° C. for 4 weeks. A suitable gel will meet the following criteria:
a) Cure: Effective cure using a DYMAX brand Mercury Fusion “D” bulb F300S 12″ Wide Conveyor or a DYMAX brand LED FX1250 conveyor.
b) Cure time: 2 UV passes at a belt speed of 10 feet per minute (FPM), more preferably 1 UV pass at a belt speed of 20 FPM or faster.
c) Thickness: 0.84″ thick pouch cures in 2 passes at belt speed of 10 FPM, more preferably 1″ thick pouch cures in 1 pass at a belt speed of 20 FPM.
d) Creep: pouch has equal to or less than 10% change in length in 24 hour via an open bag creep test at 50° C., and more preferably equal to or less than 10% change in length after the open bag creep test at 50° C. followed by 100 syneresis freeze/thaw cycles, and even more preferably after 300 freeze/thaw cycles.
e) Syneresis/Free wax: pouch has equal to or less than 1% wt syneresis when tested for 500 freeze/thaw cycles, more preferably equal to or less than 1% wt syneresis when tested for 1000 freeze/thaw cycles.

### Phase Change Material

The phase change material is a heat-absorbing material that has a melting point at about −30° C. to about 150° C., more preferably −30° C. to about 80° C., and is hydrophobic. The PCM can be selected from straight chain alkanes, alcohols, organic acids, and aliphatic acids containing at least 6 carbon atoms, and mixtures thereof. More specifically, suitable hydrophobic materials include, but are not limited to, aliphatic hydrocarbyl compounds such as saturated or unsaturated C₁₀-C₄₀ hydrocarbons, which are branched or preferably linear; cyclic hydrocarbons; aromatic hydrocarbyl compounds; C₁-C₄₀-alkyl-substituted aromatic hydrocarbons; saturated or unsaturated C₆-C₃₀-fatty acids; fatty alcohols; C-esters; and natural and synthetic waxes.

Examples of aliphatic hydrocarbyl compounds such as saturated or unsaturated C₁₀-C₄₀ hydrocarbons, which are branched or preferably linear, include, but are not limited to n-tridecane, n-tetradecane, n-pentadecane, n-hexadecane, n-heptadecane, n-octadecane, n-nonadecane, n-eicosane, n-heneicosane, n-docosane, n-tricosane, n-tetracosane, n-pentacosane, n-hexacosane, n-heptacosane, and n-octacosane, which are listed in the Table 1 below with their melting points. These PCMs are sometimes called paraffinic hydrocarbons and their melting point is directly related to the number of carbon atoms.

TABLE 1

| Compound Name | Carbon Atoms | Melting Point (° C.) |
|---|---|---|
| n-Octacosane | 28 | 61.4 |
| n-Heptacosane | 27 | 59.0 |
| n-Hexacosane | 26 | 56.4 |
| n-Pentacosane | 25 | 53.7 |
| n-Tetracosane | 24 | 50.9 |
| n-Tricosane | 23 | 47.6 |
| n-Docosane | 22 | 44.4 |
| n-Heneicosane | 21 | 40.5 |
| n-Eicosane | 20 | 36.8 |
| n-Nonadecane | 19 | 32.1 |
| n-Octadecane | 18 | 28.2 |
| n-Heptadecane | 17 | 22.0 |
| n-Hexadecane | 16 | 18.2 |
| n-Pentadecane | 15 | 10.0 |
| n-Tetradecane | 14 | 5.9 |
| n-Tridecane | 13 | −5.5 |

Based on the melting points of the alkanes in Table 1, it is often desired for the n-alkane to have 14 to 18 carbons, since these temperatures are useful for cold packs and temperature control for shipping goods (e.g. these materials can be used to customize PCMs with phase change temperatures ranging from +2° C. to +28° C.).

Examples of cyclic hydrocarbons include, but are not limited to, cyclohexane, cyclooctane, and cyclodecane. Examples of aromatic hydrocarbyl compounds include, but are not limited to, benzene, naphthalene, biphenyl, o- or n-terphenyl. Examples of C₁-C₄₀-alkyl-substituted aromatic hydrocarbons include, but are not limited to, dodecylbenzene, tetradecylbenzene, hexadecylbenzene, hexylnaphthalene or decyinaphthalene. Examples of saturated or unsaturated C₆-C₃₀-fatty acids include, but are not limited to, lauric, stearic, oleic, linoleic, caprylic, capric, myristic, palmitic, behenic acid, and eutectic mixtures thereof, including mixtures with other PCMs described herein. Examples of fatty alcohols include, but are not limited to, lauryl, stearyl, oleyl, myristyl, caprylic, capric, and cetyl alcohols, mixtures such as coconut fatty alcohol, and the so-called oxo alcohols which are obtained by hydroformylation of α-olefins and further reactions. Examples of C-esters include, but are not limited to, C₁-C₁₀-alkyl esters of fatty acids, such as methyl laurate, methyl myristate, propyl palmitate, methyl stearate or methyl palmitate, and their eutectic mixtures or methyl cinnamate. Examples of natural and synthetic waxes include, but are not limited to, montan acid waxes, montan ester waxes, polyethylene wax, oxidized waxes, polyvinyl ether wax, and ethylene vinyl acetate wax.

Blends of two or more PCMs are often utilized to achieve a specific melting point by taking advantage of eutectic mixture principles. An example of commercially available PCMs are sold under the brand name PURETEMP® from PureTemp, LLC. Many different PCMs are available under this brand name, with the number used therewith indicating the transition temperature from liquid to solid. For example, PURETEMP® 18 and PURETEMP® 4 were used in the working examples herein, but the PCM is not limited to those transition temperatures.

### Rubber Polymer

In co-pending application U.S. Ser. No. 17/187,033, Applicant indicated that resins that are likely to be soluble in a hydrophobic PCM include rubber elastomers such as silicone rubber (PDMS), polybutadiene, polyisoprene, polyisobutylene, butyl rubber, EPDM, styrene butadiene rubbers, and styrene ethylene rubbers, and that heat would likely be needed for styrene isoprene styrene (SIS), styrene butadiene styrene (SBS) and styrene ethylene butylene styrene (SEBS). After myriad experiments, it has been determined that the majority of epoxies, urethanes, silicones, polyesters and polyether acrylates have solubility issues with n-alkanes, and that SEP, SEPS, SEEPS, SEBS, S-EB/S-S, and ERS, function as thickeners rather than as the primary gelling agent because they lack polymerizable functional groups. The experiments revealed that both high vinyl rubber polymers and high or medium/low cis rubber polymers were suitable as a primary gelling agent, typically those having isoprene or butadiene rubber sections, without the need for a crosslinker. Nonlimiting examples include isoprene rubber (IR), a polybutadiene rubber (BR), styrene-butadiene-styrene rubber (SBS), styrene-isoprene-styrene (SIS), and a styrene butadiene rubber (SBR). In one embodiment, the styrene butadiene rubber is a solution polymerized styrene-butadiene partial block copolymer (S-SBR).

Polybutadiene: For the purposes of this specification, a high vinyl polymer is one that has greater than 40% wt/wt of 1,2 vinyl pendant groups with reference to polybutadiene, a medium vinyl polymer has greater than 10% up to 40% wt/wt of 1,2, vinyl pendant groups with respect to the polybutadiene, and a low vinyl polymer has less than 10% wt/wt of 1,2, vinyl pendant groups with respect to the polybutadiene.

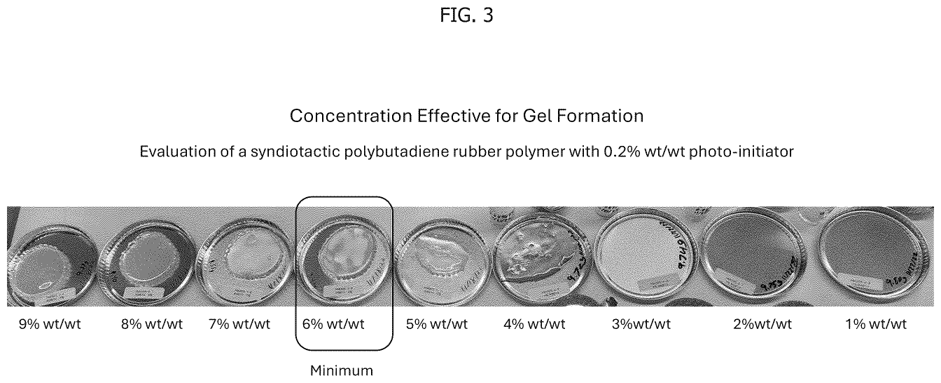

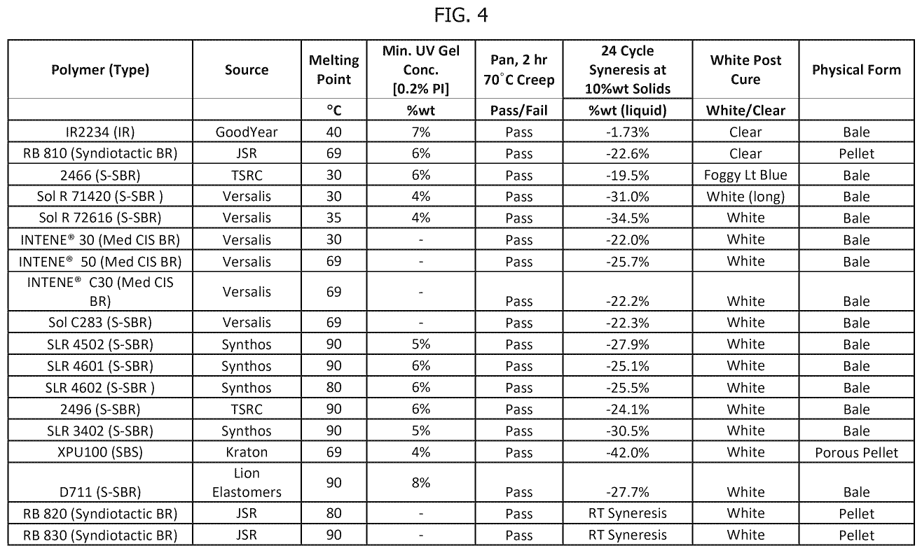

Myriad cis 1,4, trans 1,4 and vinyl 1,2 amounts (with respect to the polybutadiene) were evaluated, along with the catalyst system used to make the polymer, and key polymer characteristics (e.g., Mooney Viscosity, Molecular Weight, Molecular distribution, and glass Transition temperature, T_{g}). The candidates were ranked, from most desirable to least desirable, primarily using the data shown in FIG. 4, which includes the pumpable amount (% wt) at a reference temperature, the minimum gelation concentration (at 0.2% photoinitiator as default), pan creep (70° C. for 2 hours), pan syneresis (24 cycles, 10% wt solids), and flow characteristics at both room temperature and 70° C. Also considered are the post cure characteristics over time; specifically, does the cured pan sample remain clear, foggy or turn white (opaque). Samples that remain clear for long periods of time are “high preferred,” in combination with those that exhibit low syneresis (target <1% wt at 24 cycles), and good creep resistance (passing 70° C. for 2 hours while maintaining shape stability). FIG. 3 shows the determination of minimum gel concentration for a syndiotactic polybutadiene rubber polymer using 0.2% wt/wt BAPO photoinitiator, with n-tetradecane (PCM6). FIG. 6 shows 10% wt/wt of a syndiotactic polybutadiene rubber, with the addition of 5% wt/wt G1701 (SEP), with 0.2% wt/wt photoinitiator. This sample had low overall syneresis (1.5% wt after 100 cycles). Polybutadiene has:

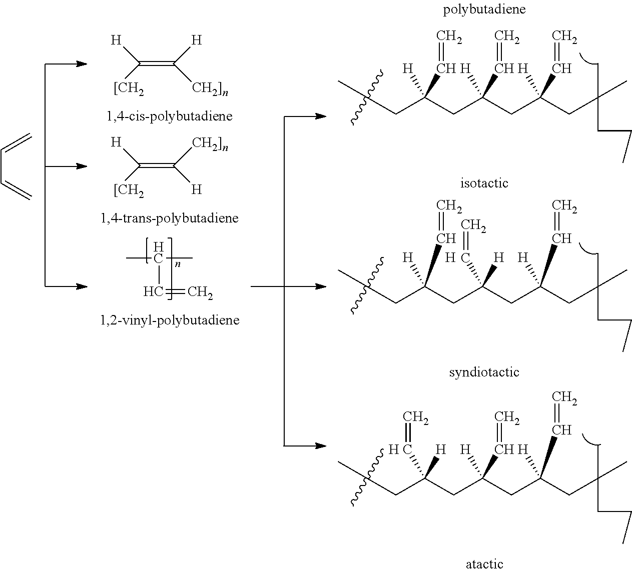

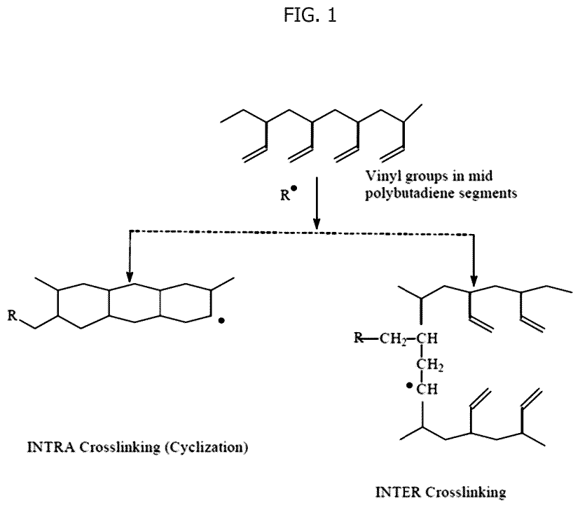

The vinyl-1,2 pendant group is generally more preferred than the cis-1,4 and trans 1,4 configurations because it is more readily available for inter- and/or intra-chain crosslinking and/or polymerization. It is theorized that crosslinking could be occurring after reaction of the polybutadiene groups with a free radical generating photoinitiator, such as BAPO, according to the reaction scheme set forth in FIG. 1. As shown above, the vinyl-1,2 pendant group can be organized on the backbone as isotactic groups (all on one side), as syndiotactic groups (alternating sides), or as atactic groups (random sides). Through a myriad of experiments and trials, it was found that high 1,2 vinyls, both atactic and syndiotactic, are good candidates as a primary gelling agent.

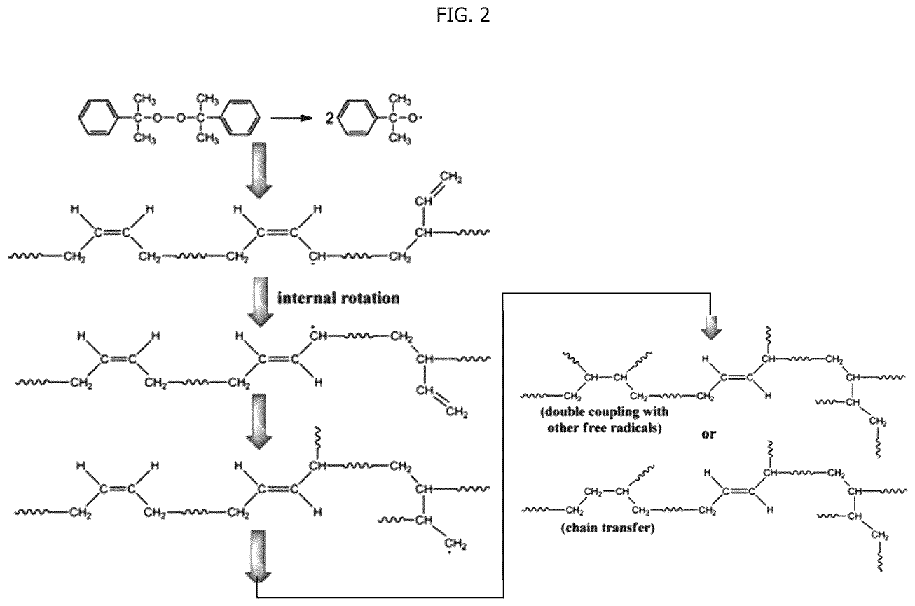

It was also found, unexpectedly, that polybutadiene polymers containing low (<10% wt with respect to polybutadiene) amounts of 1,2 vinyl pendant groups (e.g., medium 1,4 cis and high 1,4 cis) could be cured into shape stable gels, as noted in FIG. 4B under “minimum UV Gel concentration” (any sample with a value shown was cured into a gel and was able to be fully characterized). For example, BUDENE® 1280 rubber by Goodyear (1.5% wt 1,2 vinyl pendant groups, 96% wt 1,4 cis) cured into a gel with relatively low syneresis, passed creep testing and remained clear for up to 4 weeks; similar results were seen with Sci Poly CAT 571 (1.1% wt 1,2 vinyl, 98.5% wt 1,4 cis), BUDENE® 1208 (1.5% wt 1,2 vinyl, 97.0% wt 1,4 cis) and BUDENE® 1224 (0.5% wt 1,2 vinyl, 97.0% wt 1,2 vinyl). Other examples include INTENE® 30 AF by Versalis, which is a solution polymerized low cis (38%) polybutadiene, and INTENE® 50, which is also a solution polymerized low cis (38%) polybutadiene with a Mooney viscosity of 48 MU. A proposed reaction scheme for method of cure of low 1,2 vinyl/med to high 1,4 cis polybutadiene is shown in FIG. 2.

Polyisoprene has:

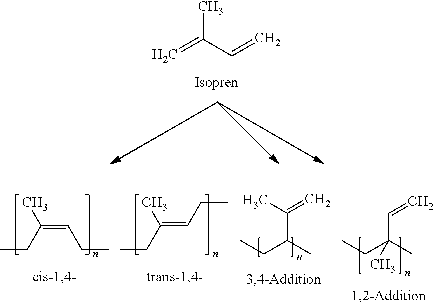

According to sources reviewed during the experimental stage, including conversations with suppliers of medium/high cis 1,4-type rubber polymers, the cis 1,4- and trans 1,4-groups were indicated as either not UV curable or not recommended for UV cure with PCMs. Experiments evidenced that high cis and medium/low cis polybutadiene and isoprene rubbers did in fact cure. Most of the rubber polymers evaluated are typically used in the production of tires for vehicles. In one embodiment, the rubber polymer is medium cis butadiene rubber having a cis 1,4-content of between 35% to 40% wt/wt, with respect to the polybutadiene. In another embodiment, the rubber polymer is a high cis 1,4-butadiene having a cis content of at least 90% wt/wt, or of at least 98% wt/wt, with respect to polybutadiene. In yet another embodiment, the rubber polymer, is a polyisoprene having a medium to high 1,2-addition/3,4-addition (of at least 60%) with respect to polyisoprene.

The first test for each rubber polymer is a small scale solubility test in an n-alkane PCM, referred to herein as “vial solubility” and described in detail in Working Example 1. As noted above, the rubber polymer is one that is soluble in a hydrophobic PCM.

The experiments evidence that a high vinyl 1,2-polybutadiene rubber polymer having a minimum weight average molecular weight average (Mw) of 50,000 g/mol were suitable as a primary gelling agent, preferably a minimum Mw of 100,000 g/mol. Lower molecular weight rubber pre-polymers and oligomers were tested, but did not UV cure, as shown in FIG. 4B. The high vinyl rubber polymer and medium/high cis polybutadiene rubbers preferably have a dissolution temperature of less than 100° C., more preferably equal to or less than 90° C., and even more preferably less than 75° C. In some embodiments, the dissolution point of the rubber polymers are in a range of 30° C. to 40° C. (completed at room temperature, but the mixture temperature increased due to shear heating). In other embodiments, the dissolution point of the rubber polymers are in a range of 65° C. to 75° C.

In one embodiment, the primary gelling agent is a high vinyl 1,2-polybutadiene atactic linear polymer with a vinyl content of 77%, with a Tg of −31° C. and a Mooney viscosity (ML (1+4), 100° C.) of 70. Note: Mooney viscosity of rubber “ML 1+4 100° C.” refers to a measurement of a rubber compound's viscosity, taken using a Mooney viscometer at a temperature of 100° C., with a test setting of “ML 1+4” which means the sample is preheated for 1 minute and the viscosity is measured for 4 minutes after starting the rotor. In another embodiment, the primary gelling agent is a high vinyl 1,2-polybutadiene polymer that is syndiotactic, with a Mw of 100,000 g/mol a melting point of 71° C., and a 1,2-polybutadiene vinyl content of 90% wt/wt. In another embodiment, the primary gelling agent is a random copolymer high vinyl solution polymerized styrene butadiene rubber (S-SBR), with a styrene content of 15% to 21% wt/wt, a 1,2-vinyl content of 48% to 68% with respect to polybutadiene, and a Mooney viscosity between 58 and 75. For complete details on the polybutadiene based polymers evaluated, see FIGS. 4A and 4B.

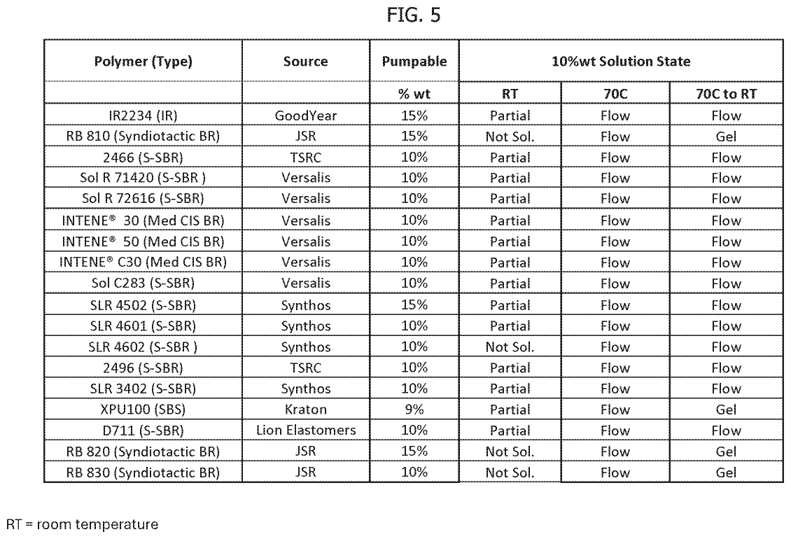

In another embodiment, the primary gelling agent is a medium to high [1,2 add/3,4 add polyisoprene rubber], with a [1,2 add/3,4 add] content of 60% or more, with a Tg of −11° C., and a Mooney viscosity (ML(1+4), 100° C.) of 75. In another embodiment, the primary gelling agent is a high 1,4 cis polyisoprene rubber, with >90% 1,4 cis content and up to 6.5% [1,2 add/3,4 add] polyisoprene rubber with a money viscosity (ML(1+4), 100° C.) of approximately 60; these polymers show higher minimum gel concentrations than their polybutadiene counterparts, but have significantly improved (lower) syneresis values, as shown in FIGS. 5A and 5B. In general, the mechanical properties (strength, creep resistance) of the polyisoprenes were found to be not as robust as polybutadienes, while other properties (syneresis) are significantly improved.

It should be noted that, for the polyisoprene rubbers, high 1,4-trans (>97%) showed partial to no cure under the same conditions as above; furthermore, the maximum molecular weight (Mw) that showed any evidence of cure was 400,000 g/mole (Sci Poly CAT, >97% 1,4 trans content). A copolymer of liquid IR/BR (Kuraray L-IR-390), Mw=48,000 g/mole did show partial cure. However, none of the liquid isoprene rubbers, nor the SIS triblock copolymers (H5127, H5125) showed any evidence of cure. This indicates that, although polyisoprenes with a substantial number of reactive groups can make a gel with acceptable properties, preference is given to polybutadienes.

High vinyl rubber polymers are available from various sources in the form of pellets, powder, bales, and liquids. These are liquid if they have a low enough molecular weight. Experiments revealed, as shown in FIG. 4B and FIG. 5B, that the more suitable high vinyl rubber polymers were available in the form of bales or pellets.

The pre (radiation)-cured solution must be pumpable and of low enough viscosity such that mixing in one tank (no transfers) is possible, with a total allowable mixing time of <4 hours), ideal mixing time <1 hour. The mixing temperature should be a maximum of 85° C., ideally <70° C., and most preferably, at room temperature. For processability, the viscosity of the hot (>50° C.), formulation must be <2000 cP, ideally <500 cP. It is specifically desired that the formulation easily flows at or close to ambient temperature (e.g., viscosity <<500 cP at 22° C.).

### Thickeners

A secondary “thickener” resin can be present as 0% wt/wt to 15% wt/wt of the formulation, more preferably 1% to 10% wt/wt and, optionally, a secondary resin can be present as 0 to 5% wt/wt of the formulation, more preferably 1% to 2% wt/wt. The secondary “thickener” resin and the secondary resin comprise hydrogenated styrenic block copolymers (SBCs). Example SBCs are available under the KRATON™ brand from Kraton Corporation and SEPTON® brand from Kuraray, including styrene-ethylene-propylene (SEP) polymer, styrene-ethylene-propylene-styrene (SEPS) polymer, styrene-ethylene-ethylene-propylene-styrene (SEEPS) polymer, styrene-ethylene-butylene-styrene (SEBS) polymer, SEBS with an enhanced rubber segment (ERS), styrene-ethylene butylene/styrene-styrene (S-EB/S-S) polymer, and combinations thereof. In one embodiment, the hydrogenated styrenic block copolymer is a diblock SEP. The diblock SEP can have styrene as 25% to 40% wt/wt thereof and can be 100% diblock in structure. In another embodiment, the hydrogenated styrenic block copolymer is a diblock or triblock copolymer.

Through extensive testing, it was determined that the secondary “thickener” resin is preferably a fully (100%) di-block SEP, including, but not limited to: GLOBALPRENE™ 8501U a linear and clear styrene-ethylene/propylene block copolymer (SEPS) by LCY Group, SEPTON® S1020 styrene ethylene propylene block copolymer, KRATON™ G1701 and/or KRATON™ G1702 hydrogenated styrenic block copolymers. Not only do these thickeners provide particularly good thickening efficiency, but they also have the significantly important benefit of limiting/minimizing syneresis.

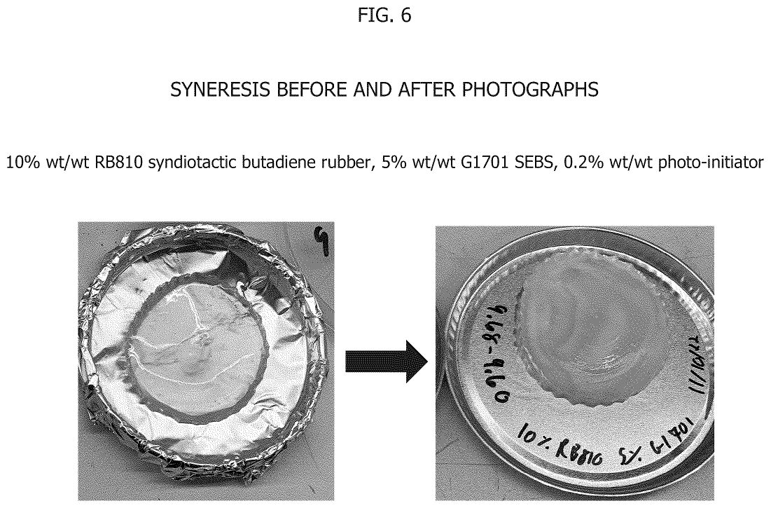

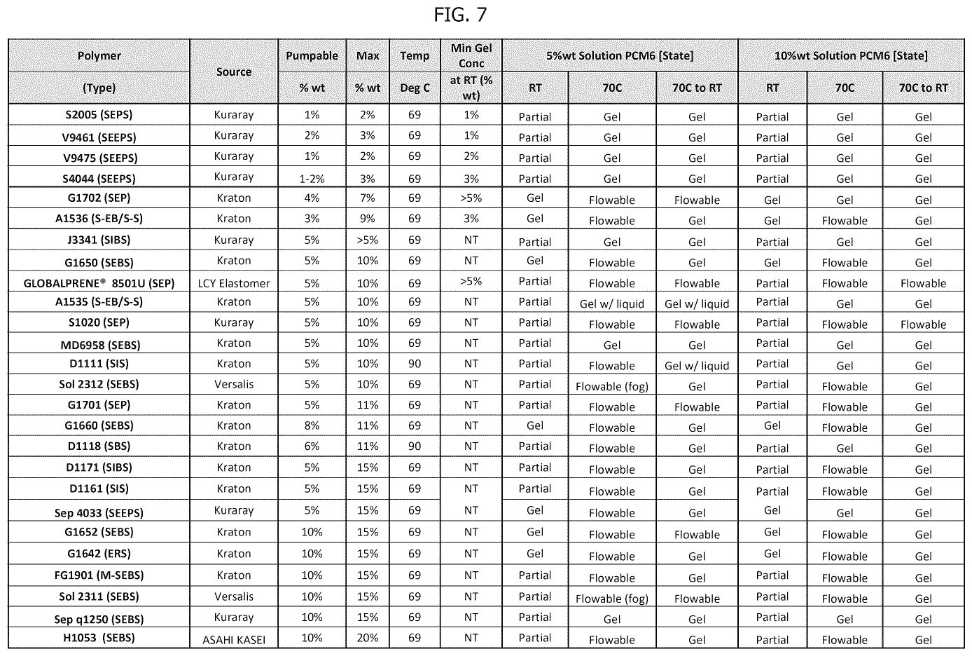

FIG. 7 is a chart summarizing the test data for all the thickeners that are considered suitable for use in thermoset thermal energy gels. As is shown in FIG. 7, the highest efficiency thickeners show what was deemed the “pumpable” % wt in the range of 1% wt to 10% wt of PCM, which corresponded to “maximum” (highest amount that could be incorporated into the PCM at the noted processing temperature) of 2% wt to 20% wt of PCM. Especially preferred are SEPTON® S2005 an SEPS, from Kuraray and SEPTON® V9461, V9475, S4044 SEEPS, also from Kuraray. All of these materials formed gels at 5% wt/PCM at 70° C. Considering all candidates, the minimum concentration at which a gel formed at room temperature, ranged from 1% wt/wt to 4% wt/wt for all samples except the SEP di-block copolymers, which ranged from 5% wt to 8% wt. Furthermore, 10% wt solutions of thickeners in PCM, showed that after being heated to 70° C., and cooled back to room temperature, all materials gelled, with the exception of GLOBALPRENE™ 8501U and SEPTON® S1020 SEPS.

Some of the secondary resins have a melt flow index of less than 15 g/10 min at 230° C. for 5 kg, or more preferably a melt flow index of less than or equal to 5 g/10 min at 230° C. for 5 kg and/or less than 1.8 g/10 minutes at 200° C. for 10 kg (see Tables 2 and 3, respectively).

TABLE 2
Secondary Resins (KRATON brand resins)

| | | | | | Brookfield | |
|---|---|---|---|---|---|---|
| | | | Styrene/ | Melt Index | Viscosity (cp) at | |
| KRATON ™ | | Diblock | Rubber | (g/10 min/ | 25° C. | |
| Name | Polymer/type | (%) | Ratio | 230° C./5 kg) | 10% w | 25% w |
| G1652 | SEBS/linear/tri-block | <1 | 30/70 | 5 | 30 | 1800 |
| A1536 | SEBS/linear/mid-block | — | 42/58 | 3 | — | — |
| G1701 | SEP/di-block | 100 | 37/63 | <1 | — | >50000 |
| G1645 | SEBS/linear/ERS | 7 | 13/87 | 3 | — | — |
| G1730 | SEBS/linear/tri-block | <1 | 20/80 | 11 | 35 | 1980 |
| G1660 | SEBS/linear/tri-block | — | 31/69 | <1 | 50 | 8000 |
| G1702 | SEP/di-block | 100 | 28/72 | <1 | 280 | 50000 |
| G1650 | SEBS/linear/tri-block | <1 | 30/70 | <1 | — | 8000 |
| G1642 | SEBS/linear/ERS | <1 | 21/79 | <1 | — | 1300 |

TABLE 3
Secondary Resins (Other)

| | | | | Melt Index | Brookfield | |
|---|---|---|---|---|---|---|
| | | | Styrene/ | (g/10 min/ | Viscosity (cp) at | |
| Others (Trade | | Diblock | Rubber | 200° C./ | 25° C. | |
| Name) | Polymer/type | (%) | Ratio | 10 kg) | 10% w | 25% w |
| SEPTON ® S1020 | SEP/di-block | 100 | 36/72 | 1.8 | 40 | — |
| SEPTON ® S2005 | SEPS/tri-block | — | 20/80 | No flow | 1700 | — |
| SEPTON ® S4033 | SEEPS/tri- | — | 30/70 | <0.1 | 50 | — |
| | block | | | | | |
| SEPTON ® S4044 | SEEPS/tri- | — | 32/68 | No flow | 460 | — |
| | block | | | | | |
| SEPTON ® V9461 | SEEPS (xl-able) | — | 30/70 | No flow | — | — |
| SEPTON ® V9475 | SEEPS (xl-able) | — | 30/70 | No flow | — | — |
| GLOBALPRENE ™ | SEP/di-block | 100 | 37/63 | — | <700 | — |
| 8501U | | | | | | |

### Photoinitiator

The photoinitiator is one that is soluble in the hydrophobic phase change material and is present as 0.02% wt/wt to 1% wt/wt of the gel, more preferably as 0.02% wt/wt to 0.5% wt/wt. A Norrish Type I photoinitiator is preferred, such as a phosphine oxide. The photoinitiator can be a phenyl bis(2,4,6-trimethyl benzoyl)-phosphine oxide (OMNIRAD® 819), a 2,4,6-trimethylbenzoyl-diphenyl phosphine oxide (OMNIRAD® TPO), a 1-hydroxycyclohexyl-phenyl ketone (OMNIRAD® 184), a blend of benzophenone and 1-hydroxycyclohexyl-phenyl ketone (OMNIRAD® 500), a 2-hydroxy-2-methyl-1-phenylpropanone (OMNIRAD® 1173), a blend of 2,4,6-trimethylbenzoyl-diphenyl phosphine oxide and 2-hydroxy-2-methylpropiophenone (OMNIRAD® 4265), bis-acylphosphine oxide (BPO), and ethyl(2,4,6-trimethylbenzoyl)-phenyl phosphinate (OMNIRAD® TPO-L).

Additional photo initiators, which are liquid at ambient conditions, which have been determined to be compatible with the hydrophobic PCM based pre-cured system included, but are not limited to: a blend of oxy-phenyl-acetic acid 2-(2-oxo-2-phenyl-acetoxy-ethoxy)-ethyl ester and oxy-phenyl-acetic acid 2-(2-hydroxy-ethoxy) ethyl ester (OMNIRAD® 754), a blend of OMNIRAD® 819 and OMNIRAD® TPO-L (OMNIRAD® 2100), a blend of OMNIRAD® 1173, OMNIRAD® TPO-L and OMNIRAD® 819 (OMNIRAD® 2022), methyl-benzoyl-formate (GENOCURE® MBF), di-methyl-hydroxy-acetophenone (GENOCURE® DMHA), Oligomeric alpha hydroxy ketone (CHIVACURE® 70), a blend of CHIVACURE® 70 and OMNIRAD® 1173 (CHIVACURE® 100), as well as a blend of GENOCURE® DHMA and OMNIRAD® TPO (GENOCURE® LTD).

The shape stable, thermoset PCM gel has a polymeric network formed by the resin and the cross-linker. The PCM can be considered as macroencapsulated by the polymeric network. In the case where secondary resins are used, the gel may also be characterized by having a physical gel point within the range of room temperature to 50° C. and being conformable, shock absorbing, cuttable, creep resistant at temperatures up to 50° C., and still generally flexible when frozen. Further, in its liquid state, the gel is clear/translucent and completely homogenous. Also, in its liquid state, i.e., before being cured, the gel solution has a viscosity that is pumpable through a sachet machine and/or vertical form fill and seal (VFFS) machine for filling pouches therewith. In one embodiment, the viscosity of the gel solution is less than 5000 cps at 60° C. In another embodiment, the viscosity of the gel solution is less than 1000 cps at 60° C., and more preferably less than 500 cps at 60° C.

The solid gel can be UV-cured (or cut) into beads or any other pre-selected shape, which can then be inserted into a pliable or rigid container for a variety of end applications. But, more advantageously, the liquid radiation curable PCM solution can be introduced into a pliable or rigid container of a preselected shape and cured directly therein. In most embodiments, the container is selected to be transmissive of radiation. However, the liquid radiation curable PCM solution can be cured from an open end of a container if the container is not transmissive of radiation. In one example embodiment, the gels can be housed in a container to form a cold pack, typically permanently enclosing the thermal gel therein. The container can be a rigid container that retains a preselected shape and configuration, or a flexible container that is conformable to a surface against which the flexible container is seated. A rigid container may be made of glass, metal, hard-plastic, Styrofoam containers, or other suitable materials. A flexible container may be made of polymer films, plastics (such as a plastic in the form of a bag or sachet), watertight fabrics, or other suitable materials.

Methods for making thermoset thermal energy gel and the solution from which the gel is formed are disclosed herein. The preferred primary (radiation curable) gelling agent is heated to at most 85° C., more preferred at most 70° C., to allow ease of handling when the material is in its original solid (pellet, crumb, bale) format, so as to not thermally damage the polymer and/or evaporate the hydrophobic phase change material being used. Ideally, this process can be done at room temperature (no heat needed). The radiation curable, primary gelling agent is one that is soluble in the hydrophobic phase change material, ideally at room temperature, or slightly above room temperature. Next, the primary gelling agent is mixed/stirred until full dissolution occurs to make a first mixture. A secondary thickener may be added at this time, and mixing/stirring continued until full dissolution occurs, to make a second mixture. A photoinitiator is added to the second mixture with stirring to form the final mixture, which may or may not be slightly heated (e.g., up to 40° C.) to ensure complete dissolution of the photoinitiator. The photoinitiator is also soluble in the hydrophobic phase change material. The final mixture is cooled to ambient temperature and placed in one or more selected containers, which may be rigid or flexible as described above. Alternatively, the final mixture can be heated, to reduce the viscosity such that it is pumpable, and supplied directly to a flexible film packaging machine (Sachet or VFFS), where it is packaged hot, then proceeds (while hot) to be immediately radiation cured to make the thermal energy gel.

Alternatively, the thickener can be added to the hydrophobic phase change material, with mixing at room temperature, or with heat, until dissolution occurs to make a first mixture, followed by the addition of the primary gelling agent with mixing until dissolution to make the second mixture, ideally at room temperature, or with heat. This would be followed by the addition of the photoinitiator (with or without heating, as needed) to make the final mixture. The cooling and placing in containers may occur in any order. Lastly, the final mixture is cured by exposure to radiation, thereby forming a thermoset thermal energy gel. If the final mixture shows any evidence of opacity (visually) at a given temperature, whether it be room temperature, or a temperature exceeding room temperature, the temperature of the final mixture should be increased such that curing is attempted only when the final mixture is visually clear and completely homogeneous. It is anticipated that the temperature of the final mixture, immediately before being cured, should be in the range of 20° C. to 70° C., ideally within the range of 45° C. to 60° C. Keeping the mixture clear and homogeneous when radiation curing takes place, makes for a more consistent end product, and is highly recommended.

The photoinitiator is added last and can be added at any time after formulation of the second mixture, even as much as four weeks later, i.e., the second mixture is shelf stable at room temperature without the photoinitiator. This shelf stability is especially useful in manufacturing. In one embodiment, the photoinitiator is a liquid at room temperature that is compatible with the hydrophobic phase change material, and may be added at or near room temperature, with mixing until full dissolution. In another embodiment (e.g., when the photoinitiator is a solid at room temperature), the photoinitiator may be added while the second mixture is maintained at a temperature of 40° C. with mixing for 30 minutes to 2 hours, depending on heating apparatus and its configuration. Heating the second mixture above 40° C. may also be required depending on the melt temperature of the hydrophobic phase change material.

In one embodiment, the containers in which the final mixture will be cured is a sachet or lager plastic bags that can be fluidly sealed to contain the final mixture permanently therein. Sachet and bag filling machines, which are readily available, are used to manufacture liquid filled pouches of phase change materials. As such, the final mixture can be cured in-situ after a preselected amount is placed in the container and exposed to radiation. The container may be placed in radiation flood cure equipment and/or proceed through a conveyor equipped with radiation cure capability. The radiation may be ultra-violet (UV) radiation, visible (VIS) radiation and/or electron beam (EB) radiation. A minimum surface intensity of 100 mW/cm² for a duration between 1 to 2 seconds (dose of 100 to 200 mJ/cm²) was found to cure the phase change material solutions described herein, but the times will vary relative to the intensity of the radiation, and the particular composition of the formulation.

### Working Example 1

A vial solubility test is conducted for each rubber polymer candidate by making two vials each having a 10 g total of rubber polymer and PCM 6 at 5% wt loading in Vial 1 and at 10% wt loading in Vial 2. Each vial is vortexed to mix thoroughly. Each vial sat at room temperature for 24 hours and was observed. Then, each vial was stored in an oven set at a temperature of 70° C. for 24 hours and was observed (with vortex mixing to quicken full dissolution, if needed). Next, each vial was cooled from 70° C. to room temperature for 24 hours and was observed. If the rubber polymer fully dissolved in the PCM, it was rated as a flowable solution (“Flow”). If the polymer fully dissolved and resulted in a physical gel, it was rated as “Gel.” If the polymer formed a hazy solution, or it separated into distinct layers, it was rated as partially dissolved (“Partial”). Rubber polymers that were not soluble were eliminated from further evaluation.

Radiation curable phase change solutions were formulated according to Table 4 by mixing at up to 90° C. with various rubber polymers. Each solution was cooled to ambient temperature, poured into one or more containers, and exposed to UV radiation to cure the solution into a gel. Each gel was evaluated for color/opacity over time, creep, and syneresis. More than 50 rubber polymers were tested and less than half were worthy of subsequent testing (21 of the rubber polymers did not cure to form a gel).

TABLE 4

| | | Trial 1 | Trial 2 |
|---|---|---|---|
| Name | Function | % wt/wt | % wt/wt |
| phenyl bis (2,4,6-trimethyl | Photoinitiator | 0.2 | 0.2 |
| benzoyl)-phosphine oxide | | | |
| Rubber polymer | Primary gelling agent | 10 | 15 |
| Phase Change Material | Material to Gel | Balance | Balance |

The first test is to allow the cured gel to sit at room temperature in (i) a vessel open to the air and (ii) in a sealed vessel for two weeks and then for two and a half months. The gel is visually inspected for color (transparent, foggy, or opaque) and for a visible reduction in size. See the “Post Cure Characteristics” column of FIGS. 4B and 5B.

The second test, creep, is evaluated after exposing a gel to a 70° C. environment for two hours and visual inspection for signs of “flow” of the gel. Creep is the tendency of a solid material to move slowly or slowly deform over a long period of exposure to high levels of stress, here, increasing temperature. See the “Pan, 2 hr 70° C. Creep” column of FIGS. 4B and 5B.

The third test, syneresis, is evaluated by exposing a gel to 24 freeze/thaw cycles and measuring the weight loss of the gel. For PCM6, a single freeze/thaw cycles is −12° C. for 20 minutes followed by +22° C. for 30 minutes. Syneresis is initially tested here without any thickeners, i.e., just the composition of Table 4 above, and the results for top performing rubber polymers is presented in the column “24 Cyle Syneresis at 10% wt solids” in FIGS. 4B and 5B.

Next, the concentration of each rubber polymer was decreased in 1% increments to determine the minimum concentration that would form a gel with 0.2% wt photoinitiator. See FIG. 3 for one example. The minimum concentration was typically tested if a rubber gel was soluble in the PCM, passed the creep test and had a 24 cycle syneresis of less than 50%. See the “Min. UV Gel Conc. [0.2% PI]” column in FIGS. 4B and 5B. The [*] in the first column of FIGS. 4A and 4B indicates that the minimum UV gel concentration for this material was determined at a photoinitiator concentration less than 0.2% wt/wt.

### Working Example 2

As seen in FIGS. 4B and 5B, only a few of the rubber polymers have a syneresis result that is close to the desired goal of 1% or less wt loss after 24 freeze/thaw cycles. The syneresis values ranged from 49.1% to 1.7%. While many of the rubber polymers had syneresis values of about 20% to 30%, syneresis can be adjusted by adding a thickener (also called a secondary resin) as discussed above.

As shown in FIGS. 4B and 5B, RB 810, a syndiotactic 1,2-polybutadiene rubber (also referred to as a thermoplastic elastomer (TPE) by the manufacturer JSR), has a syneresis of 22.6% after 24 freeze/thaw cycles. This sample formulation was repeated (10% wt/wt RB 810; 0.2% wt/wt photoinitiator) but with the addition of 5% wt/wt of a secondary resin (A KRATON brand SEPS sold under the product number G1701). The 100 g of the formulation was sealed in a plastic pouch, UV cured and tested for syneresis over 100 freeze/thaw cycles. The syneresis result was a 1.49% wt loss.

### Working Example 3

Based on the above experiments, the successful trials were further tested because previous testing with 10% concentrations of the top vinyl candidates demonstrated acceptable creep resistance, but did not meet the <1% for 500 F/T cycles syneresis criteria.

To address the syneresis issue, a thickener can be added to the formulation, but often a softer/weaker gel results. This testing was conducted to find promising ratios of vinyl candidates to the thickener.

### Testing Methods:

Creep Testing: Freeze-Thaw cycling where one cycle is 31.5° C. for 1 hour to 0.5° C. for 45 minutes. The creep was originally tested only soaking at 50° C. for a period of 1 hour, 2 hour, and overnight (about 19 hours), but a freeze-thaw cycling period was added after finding ShiftGen 2 would deform after cycling. The cycling period is designed to keep material in a state of incomplete freeze and thaw, which was determined through experiment. Sample size was 355 g of the ShiftGen 3 formulation. The freeze-thaw period was reduced to 30 min freeze/30 minutes thaw for 10 g samples. Creep measurement is conducted using pouches with bottom seals removed and enclosed in outer bags, which have markings at 5% and 10% pouch length with 5% being passing, but not ideal, and 10% being a failure.

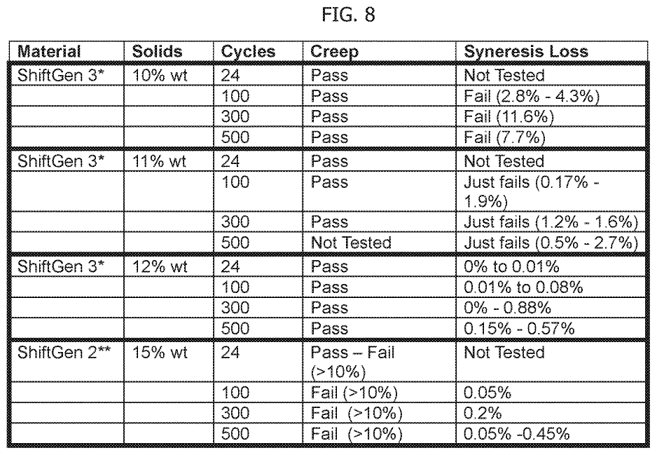

Syneresis Testing: Freeze-Thaw cycling where one cycle is 31.5° C. for 1 hour to 0.5° C. for 45 minutes. The samples were vacuum sealed and placed in a fixture that keeps each pouch from touching during cycling. Samples were pulled at target numbers of cycles, as reported in FIG. 8, removed from the vacuum bag, pouch weight recorded, holes punched through the gels above the bottom pouch seal, and placed in racks above aluminum trays to drain. First drain weights were taken after 24 hours, and repeated until either 5 total drain weights were recorded or three consecutive weights were recorded that were within +/−0.01% of each other. The measurements were recorded after 24 cycles, 100 cycles, 300 cycles, and 500 cycles (freeze-thaw cycles), Twenty four cycles was typically used for 10 g samples, but may be skipped when larger samples sizes (greater than 10 g) were evaluated.

Various vinyl polymers were mixed with a fully di-block SEP, such as KRATON™ G1702, (thickener) at 10% total solids relative to the phase change material. The phase change material used in the tests is PCM18 (a PCM blend having a transition temperature of 18° C., commercially available from Microtek Laboratories, Inc.). Other PCM blends are available from Microtek Laboratories which have various melting points, such as PCM-10, PCM6, PCM7, PCM24, PCM28, PCM32, PCM37, and PCM42, all of which are expected to have similar results to PCM18. The various tests included:

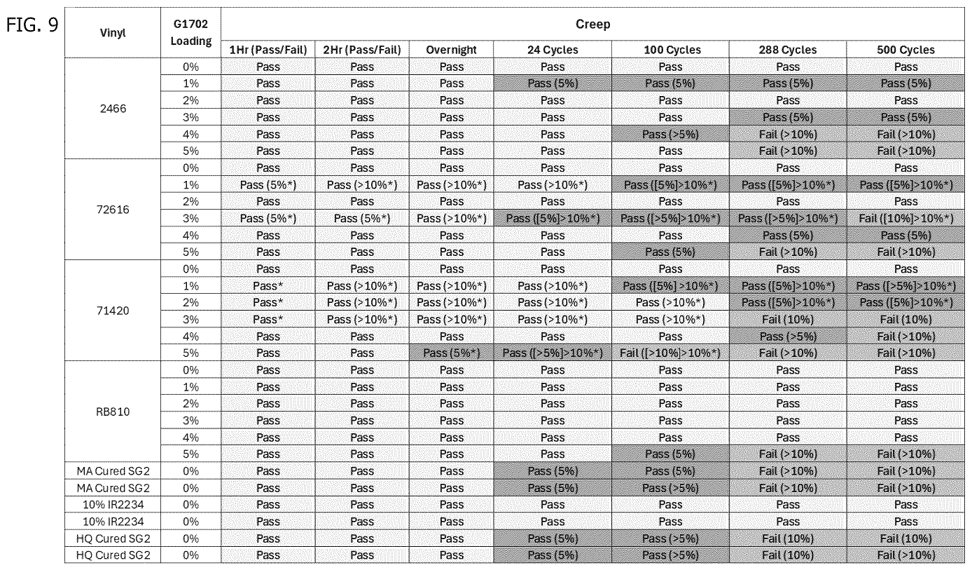

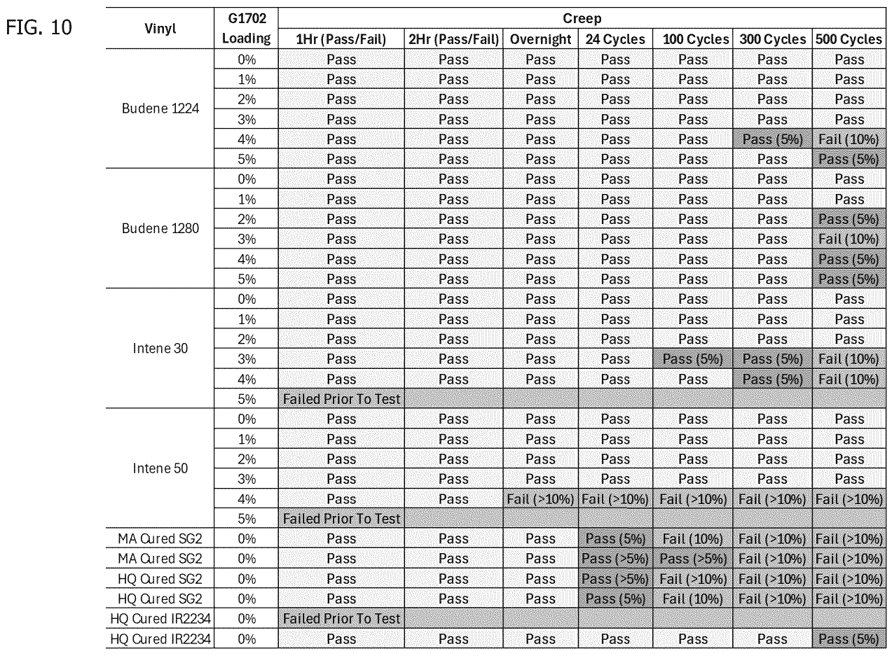

TABLE 5

| | SAMPLE | | CONTROL |
|---|---|---|---|
| | Vinyl rubber | di-block SEP | ShiftGen 2 made with MA water |
| FIG. 9 | 10-5% 2466 | 0-5% G1702 | 10% IR2234 |
| | 10-5% 72616 | 0-5% G1702 | ShiftGen 2 made with HQ water |
| | 10-5% 71420 | 0-5% G1702 | |
| | 10-5% RB 810 | 0-5% G1702 | |
| FIG. 10 | 10-5% BUDENE ® 1224 | 0-5% G1702 | |
| | 10-5% BUDENE ® 1280 | 0-5% G1702 | |
| | 10-5% INTENE ® 30 | 0-5% G1702 | |
| | 10-5% INTENE ® 50 | 0-5% G1702 | |

The data is summarized in FIGS. 9 and 10 as noted in Table 5 above. Those tests noted with a * in FIG. 9 are those that under cured, resulted in uncured material giving the appearance of creep prior to testing. Creep of uncured material was monitored; however, samples' creep were judged on creep of cured sections.

The results of the creep test were evaluated by the following criteria: (A) Acceptable results has less than 5% creep; (B) Not ideal results has greater than 5% but less than 10% creep; and (C) Unacceptable results has greater than 10% creep.

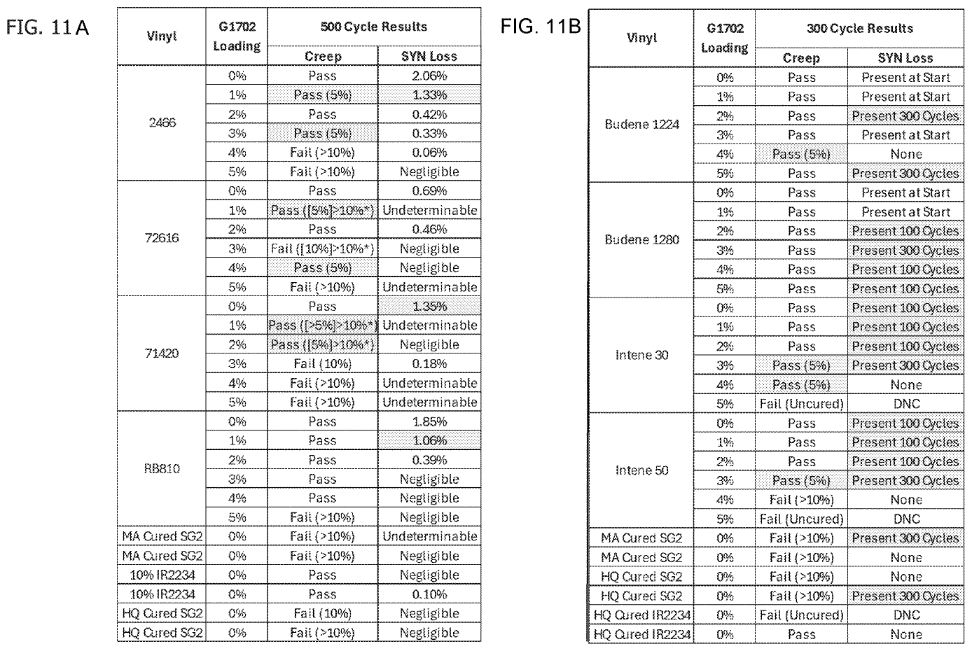

The syneresis test results are presented in FIGS. 11A and 11B for all the trials in Table 5. The syneresis was reduced with increasing amounts of KRATON™ G1702, but resulted in softer, less creep resistant gels. The higher KRATON™ G1702 concentrations did not affect all materials equally with some formulations failing prior to testing. Overall, samples were more likely to fail sooner with greater than or equal to 4% wt/wt KRATON™ G1702. While syneresis results can only be considered an estimate through this testing, <1% syneresis was measured at 2% and 3% wt/wt KRATON™ G1702 loadings without a noticeable determent to creep resistance, with the exceptions of BUDENE® 1280 and INTENE® 30 at 3% wt/wt KRATON™ G1702.

### Working Example 4

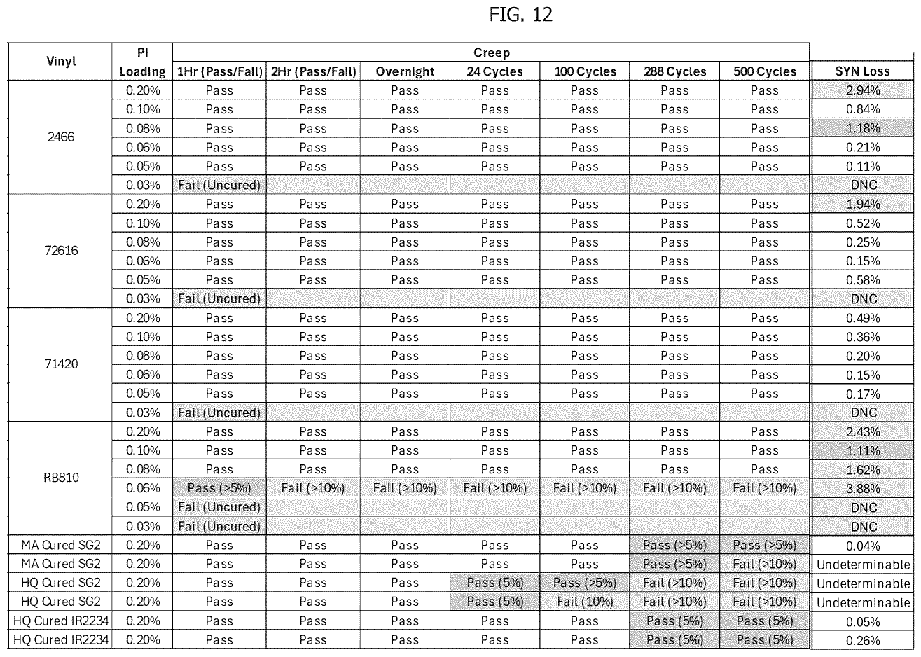

Investigation of “over crosslinking” due to excessive photoinitiator (PI) causing poor syneresis results. It is theorized that over crosslinking of the polymer network with excessive PI makes the polymer network form too tightly, causing PCM to leak out as it expands and contracts during F/T cycling. The tests were done to quantify the effect of varying concentrations of PI on Creep (before syneresis testing). The formulations in Table 6 were tested at 10% total solids in PCM18 with the following ranges of photoinitiator and diblock SEP. The results are presented in FIG. 12.

TABLE 6
SAMPLE

| Vinyl rubber | Photoinitiator | di-block SEP |
|---|---|---|
| 10% 2466 | 0.2-0.03% | 0-5% G1702 |
| 10% 72616 | 0.2-0.03% | 0-5% G1702 |
| 10% 71420 | 0.2-0.03% | 0-5% G1702 |
| 10% RB 810 | 0.2-0.03% | 0-5% G1702 |

Due to the ease in use of RB 810 and successful creep performance through 500 cycles, up to 4% loading of G1702 (6% RB 810) may be worth further investigation.

Creep tests were primarily passed until the amount of PI was below about 0.5% wt/wt for most vinyl polymers, and less than 0.8% wt/wt for vinyl polymer RB 810. The results shown in FIG. 12 confirm that syneresis is in part controlled by the degree of cure and that generally a PI concentration range can be experimentally determined for each vinyl polymer. No linear reduction in syneresis was found in relation to PI concentration. The ideal PI concentration appears to vary by material:
Vinyl polymer 2466: between 0.05% & 0.06% PI
Vinyl polymer 72616: between 0.06% & 0.08% PI
Vinyl polymer 71420: between 0.05% & 0.08% PI
Vinyl polymer RB 810: no concentration met the basic syneresis requirement

Further refinement, especially with respect to vinyl polymer RB 810 is needed.

### Working Example 5

Continued improvement of syneresis.

More formulations were made according to Table 7 below.

TABLE 7
SAMPLE

| Vinyl rubber | Photoinitiator | di-block SEP |
|---|---|---|
| 8-6% RB10 | 0 | 2-4% G1702, respectively |
| 10% 71420 | 0.1-0.05% | 0 |

Samples were vacuum wrapped and placed in a Test Equity chamber, oriented vertically in racks. Samples were cycled between 31.5° C. (60 min) and 0.5° C. (45 min) for a maximum of 500 F/T Cycles. One sample was pulled from each group at approximately 100, 300, and 500 cycles. Controls were only pulled at 300 cycles (one sample pulled) and 500 cycles (two samples pulled). Pulled samples were replaced with ShiftGen 2 (SG2) dummy samples to maintain thermal mass in test chamber through duration of the test. When pulled, samples were removed from vacuum bags and initial weights of the samples were recorded. Holes were then punched in the bottom of the pouch and samples were oriented vertically in racks over drip pans for 24 hr before taking first weight, and additional weights were taken in 24 hr. periods after, following the testing procedures set forth above in working example 3. Weights were recorded until 3 consecutive weights were recorded within +/−0.01% of each other.

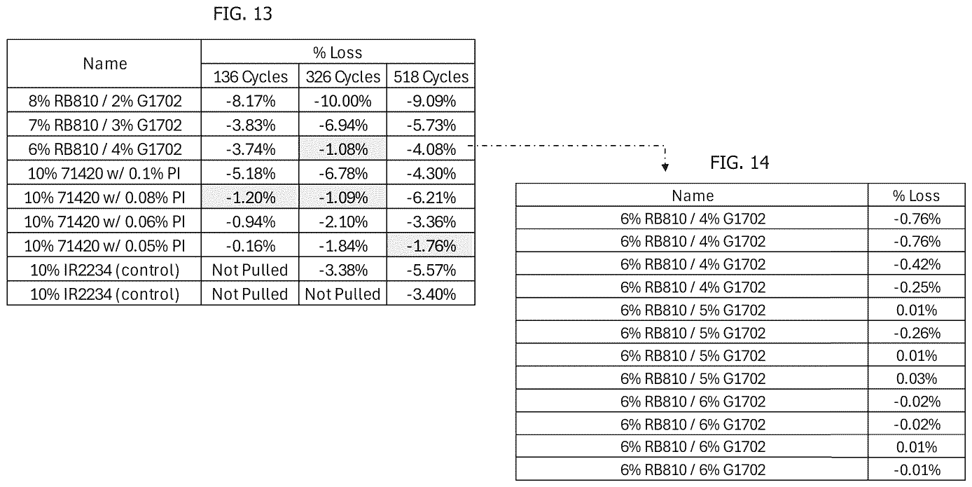

The test results are presented in FIG. 13. None of the formulations passed the syneresis requirements at 500 cycles. Some samples were close at fewer cycles. More testing is required.

### Working Example 6

For this testing, the 6% RB 810/4% G1702 formulation was chosen from working example 5 as the base formulation to modify due to it being the only vinyl candidate that comes as a pellet rather than a bale, making it an easier candidate to test and scale and it had a syneresis of −1.08% at 326 cycles. Test #1:100 cycle syneresis testing of CRT Half Size (355 g) RB 810 vinyl samples w/additional G1702 (4%, 5%, & 6% G1702 at greater than 10% wt solids). Samples were vacuum wrapped and placed in a Test Equity chamber, oriented vertically in racks and cycles according to the procedure noted in Working Example 5. The test results are presented in FIG. 14.

Through 100 cycles all samples appeared to surpass the <1% syneresis loss limit. While the samples all passed, there was a clear difference in performance between the 4% G1702 samples and the 5% & 6% G1702 samples—the 5% wt/wt and 6% wt/wt KRATON™ G1702 performing significantly better than 4% wt/wt. Based on this data, it would be reasonable to expect the 4% G1702 samples to surpass 1% loss after additional F/T Cycling. However, the performance of the 5% & 6% G1702 samples warrants further investigation.

Test #2:24 cycle syneresis testing of pan samples (~10 g) of 6% RB 810/4% G1702 with additions of additives that should improve the syneresis past ratings, such as silica powders and XLs. Sample silica powders tested included CAB-O-SIL® TS 720 fumed silica available from Cabot Corporation, AEROSIL® 200 hydrophilic fumed silica available from Evonik Industries, and ZEOFREE® 600 available from Evonik Industries. Sample crosslinkers included EB113, M210, EM229, and M360. These additives made no improvements on the formulation; hence data for these tests are omitted herein.

### Working Example 7

Test: soak (50° C.) and freeze/thaw cycling creep resistance with >10% solids. While testing appeared to show a trend towards at least one formulation meeting the syneresis target(s), creep testing was started to determine if the additional G1702 would compromise shape stability. Additionally, 6% wt RB 810/4% wt G1702 with reduced PI (0.2%->0.1% PI) was included in testing after seeing an improvement in syneresis in the 24 cycle pan syneresis test.

### Samples Tested (all PCM18 Based):

$$N = 4 , SG 2 Controls$$

$$N = 4 , 6 \% RB 810 / 4 \% G 1702 wt / wt$$

$$N = 6 , 6 \% RB 810 / 4 \% G 1702 with 0.1 \% PI wt / wt$$

$$N = 6 , 6 \% RB 810 / 5 \% G 1702 wt / wt$$

$$N = 10 , 6 \% RB 810 / 6 \% G 1702 wt / wt$$

The bottom seals were removed on the N=30 samples and were placed into outer bags with marks at 5%, and 10% of the sample length. The outer bags were fixed to the samples with tape. S-hooks were then either pressed through excess film, if available, or through tape tabs fixed to the samples. Samples were hung from a wire metal shelf in a Test Equity Chamber set to soak at 50° C. and allowed to come to temperature. The samples then continued to soak at 50° C. with checks made after 1 hr, 2 hrs, and overnight (~19 hr). After soaking at 50° C. overnight, the syneresis F/T cycling program (31.5° C. for 60 min and 0.5° C. for 45 min) was run and samples were checked at 24, 100, 300, and 500 cycles.

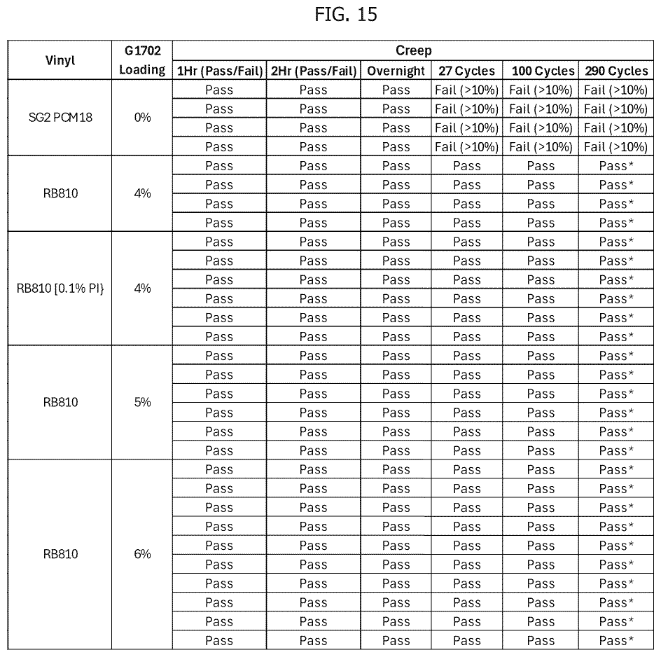

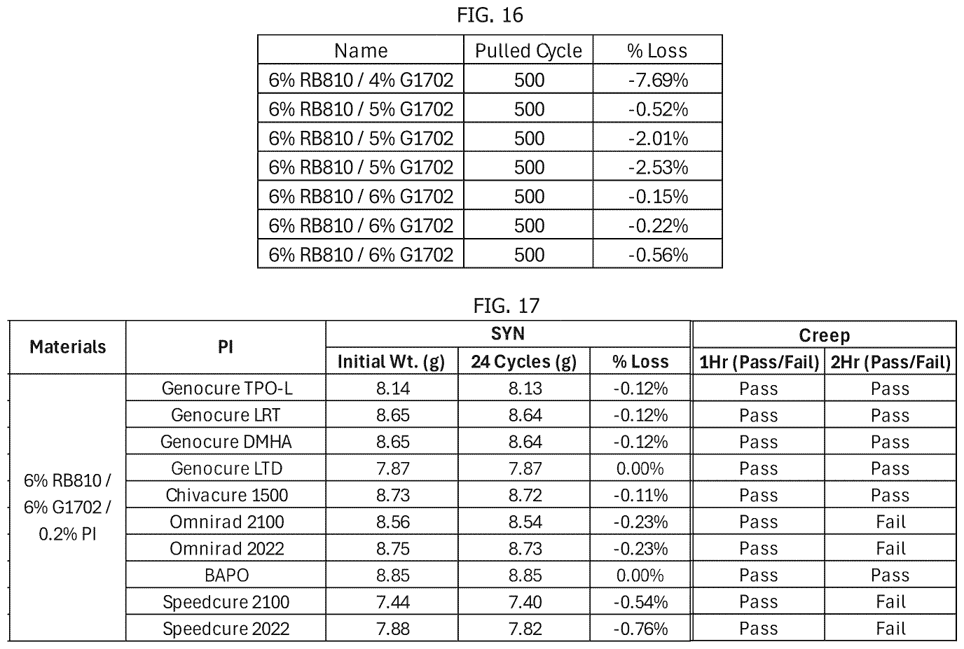

With reference to the data table presented as FIG. 15, through the initial 50° C. soak period of creep, all samples performed acceptably with no visible creep seen in any samples or controls. In the F/T cycling period, all ShiftGen 3 candidate formulations outperformed the ShiftGen 2 controls after only 24 cycles and continued to pass through 290 Cycles. This would indicate that the ShiftGen 3 candidates all improve on the creep standard established by ShiftGen 2.

While the body of all the ShiftGen 3 candidate samples appeared to be shape stable through 290 cycles, it did appear that the PCM coming out of the samples (syneresis) was thick and gelled, increasing in thickness as G1702 concentrations increased. This suggests that the G1702 was being expelled from the samples with the PCM.

Recommendations: Based on the creep results, the final formulation to be validated should be based solely on syneresis performance because the formulations will be an improvement on ShifttGen 2's creep results.

### Working Example 8

This experiment was run as a follow-up to the >10% solids 100 cycles syneresis test using PCM18. With all three >10% solids formulations appearing to result in <1% loss at 100 cycles, testing with a larger sample size was run with (a) 6% wt RB 810 and (b) G1702 at 4% wt (10% solids), 5% wt (11% solids), and 6% wt (12% Solids) to determine if the results were repeatable and if they would maintain their performance through 500 cycles (min cycle target). PCM18 samples were vacuum wrapped and placed in a Test Equity chamber, oriented vertically in racks. Samples were cycled between 31.5° C. (60 min) and 0.5° C. (45 min) for a maximum of 500 F/T Cycles.

Samples were pulled for each group at 100, 300, & 500 cycles. As samples were pulled from testing, SG2 dummy samples were used to fill replace them so that the sample thermal mass in test chamber would be comparable to previous testing. When pulled, samples were removed from vacuum bags and initial weights of the samples were recorded. Holes were then punched in the bottom of the pouch and samples were oriented vertically in racks over drip pans for 24 hr before taking first drain weight, and additional weights were taken in 24 hr periods thereafter.

Weights were recorded until 3 consecutive weights were recorded within +/−0.01% of each other or N=5 total weights had been recorded. Through 500 cycles the 6% RB 810/6% G1702 formulation successfully maintained <1% syneresis loss for all samples, meeting the formulation target requirement of <1% wt loss over 500 cycles.

### Working Example 9

### Screening the Photoinitiator

With the 6% RB 810/6% G1702/0.2% PI formulation from working example 8 appearing to meet the target creep and syneresis, the photoinitiator is explored further herein. To determine if an alternative PI could be used and meet the same targets, a quick 70° C. creep and 24 Cycle syneresis test were run on ~10 g pan samples.

The PIs tested include GENOCURE® TPO-L phosphine oxide, liquid photoinitiator, GENOCURE® LRT liquid Type I photoinitiator, GENOCURE® DMHA aromatic ketone, liquid photoinitiator, GENOCURE® LTD liquid photoinitiator blend (a 1:1 blend of GENOCURE® TPO-L phosphine oxide, liquid photoinitiator and GENOCURE® DMHA aromatic ketone, liquid photoinitiator), CHIVACURE® 1500 liquid photoinitiator blend, OMNIRAD® 2100 liquid photoinitiator, OMNIRAD® 2022 liquid photoinitiator, SPEEDCURE™ 2100 liquid photoinitiator, and SPEEDCURE™ 2022 liquid photoinitiator, and liquid bis-acylphosphine oxide (BAPO) (solid) photoinitiator. The data is presented in a chart as FIG. 17.

While the sample size was limited, the GENOCURE® LTD liquid photoinitiator blend and the BAPO photoinitiator passed the creep test at 70° C. for 2 hr and resulted in no syneresis loss after 24 cycles. All GENOCURE brand PIs and the CHIVACURE 1500 PI performed well and showed hardly any syneresis loss, indicating that each may be suitable alternatives.

### Working Example 10

This experiment was run as a final evaluation of the ShiftGen 3 (SG3) formulation (6% RB 810/6% G1702/0.2% PI) formulation's high temperature and F/T cycling creep. With previous testing demonstrating improved performance of BAPO cured SG3 over SG2 and now SG3 cured with GENOCURE® LTD photoinitiator, samples were used as the bulk samples to verify repeatability. Samples Tested (PCM18 based):

$$N = 24 , 6 \% RB 810 / 6 \% G 1702 / 0.2 \% GENOCURE ® LTD photoinitiator$$

$$N = 3 , 6 \% RB 810 / 6 \% G 1702 / 0.2 \% BAPO$$

$$N = 3 , ShiftGen 2 controls ( 7.5 \% 641 E , 6.5 \% G 1701 , 1 \% VCAP and 0.05 \% BAPO ) .$$

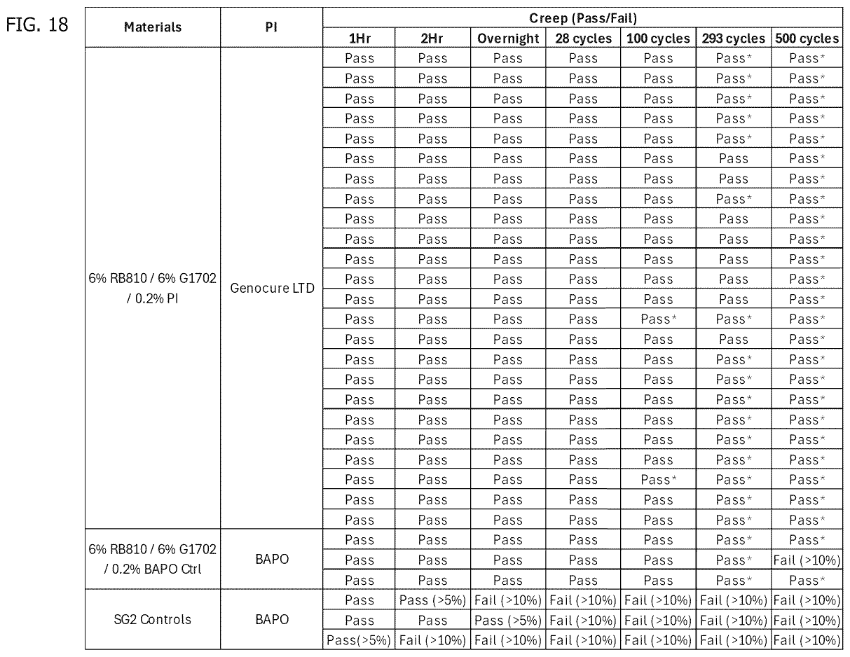

The creep data results for the above trial are presented in FIG. 18. Through about 17 hr 50° C. soak and 500 cycling, SG3 formulations clearly out preform SG2 with all SG3 sample passing soak with no issues, and N=26 of 27 SG3 samples passing through 500 F/T cycles. N=1 of 3 BAPO cured SG3 samples in this test did fail Creep after 500 cycles, and while this is a 1/3 failure, the low population of BAPO cured samples in this testing is the likely reason for this, rather than a true metric of how often a BAPO cured sample would fail at 500 cycles. Despite the failure of the N=1 BAPO cured sample, all BAPO cure samples still outperformed all SG2 controls. Additionally, it was observed that any expelled PCM was thicker as compared to the SG2 samples. This should be a benefit as the increased viscosity will reduce the mobility of the PCM in the pouch.

### Working Example 11

This experiment was run as a final evaluation of the SG3 (6% RB 810/6% G1702/0.2% PI) formulation's F/T Cycling syneresis. Previous testing demonstrated <1% syneresis loss through 500 cycles with BAPO cured SG3, SG3 cured with GENOCURE® LTD photoinitiator samples were used as the bulk sample load with a few less BAPO cured SG3 samples as a control. SG2 samples were not included as their syneresis values are well characterized. Samples Tested (PCM18 based):

$$N = 23 , 6 \% RB 810 / 6 \% G 1702 / 0.2 \% GENOCURE ® LTD$$

$$N = 11 , 6 \% RB 810 / 6 \% G 1702 / 0.2 \% BAPO$$

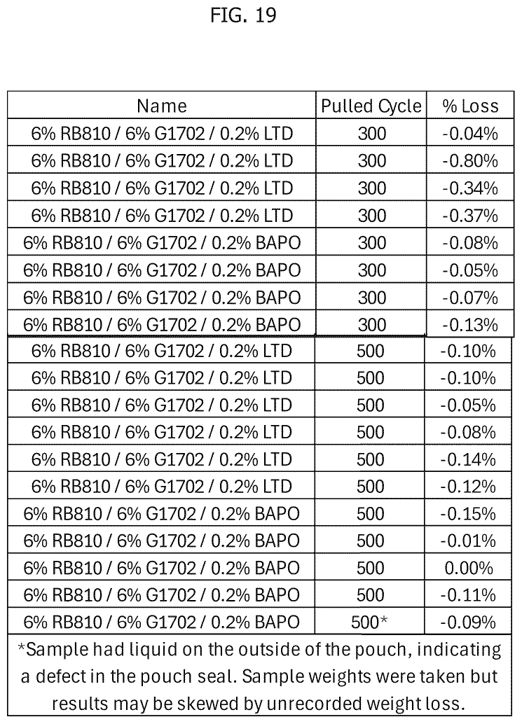

The results of the 500 cycle syneresis testing, see FIG. 19, demonstrated that SG3 loses less than 1% PCM through 500 cycle of F/T cycling. There does appear to be variance in loss, as demonstrated by more significant syneresis loss measured in 300 cycles as compared to 500 cycles. This may be a result of batch-to-batch variance or degree of cure achieved. There appears to be a slight bias towards greater syneresis loss with the GENOCURE® LTD PI compared to the BAPO PI. A greater average loss in GENOCURE® LTD PI cured samples at 300 and 500 cycles occurred. Even so, this did not result in any samples exceeding the target syneresis loss threshold.

Based on these results, either of the photoinitiators is suitable. GENOCURE® LTD being a liquid photoinitiator should result in faster integration into a formulation, but the time difference in manufacturing should be minimal.

### General Outcome of Testing

The formulation noted as having the best performance results was a 6% wt/wt syndiotactic 1,2-polybutadiene thermoplastic elastomer, 6% wt/wt linear diblock styrene-ethylene-propylene copolymer with a polystyrene content of 28%, 0.2% wt/wt GENOCURE® LTD or BAPO photoinitiator, and 88% wt/wt n-alkane PCM. The comparative composition was Applicant's own ShiftGen2, which had 15% wt solids. ShiftGen 2 can be 7.5% wt/wt BR-641 E (polybutadiene acrylate) by Bomar (formerly Dymax Oligomers & Coatings), 6.5% wt/wt KRATON™ G1701 (a diblock styrene-ethylene-propylene copolymer), 0.05% wt/wt BAPO photoinitiator, and 85% wt/wt n-alkane PCM.

As seen in FIG. 8, the new formulations at 10% wt solids at 24 cycles through 500 cycles passed the creep test, but failed the syneresis tests. The samples surpassed 1% syneresis loss for 500 freeze thaw cycles. Additionally, the loss percentages were highly variable. The new formulations at 11% wt solids, generally passed the creep test, but the syneresis loss percentage was variable through the 500 freeze-thaw cycles, with some samples passing and others failing. The new formulations at 12% wt solids passed both the creep and the syneresis loss test, i.e., the solids being defined by the wt/wt percent sum of the vinyl copolymer and the SEP diblock copolymer. In comparison, the control formulation failed the creep test, but passed the syneresis loss test. Historically, the control formulation excels at syneresis with less than 1% wt syneresis loss, consistently through 500 cycles. The control formulation tends to pass the creep test when it is a 19 hour soak at 50° C.; however, when the cycling was changed as described in the working examples herein, the samples had intermittent failures (creep greater than 10% of sample length) at 24 cycles depending on sample quality and consistently failed the test at 100 or more cycles.

### Working Example 12

The formulation noted as having the best performance results above was a 6% wt/wt syndiotactic 1,2-polybutadiene thermoplastic elastomer, 6% wt/wt linear diblock styrene-ethylene-propylene copolymer with a polystyrene content of 28%, 0.2% wt/wt GENOCURE® LTD or BAPO photoinitiator, and 87.8% wt/wt n-alkane PCM (hexadecane). This formulation was re-tested with a different PCM, PURETEMP® 4 a methyl ester phase change material. The inventors ran short on time to run a 500 cycles for the syneresis test. However, the samples were tested at 53 cycles and the syneresis loss results were in acceptable limits and it was expected to maintain such results if given time to run the full 500 cycles.

| | PCM | Pulled Cycle | % Loss |
|---|---|---|---|
| Sample 1 | PURETEMP ® 4 | 53 | 0.01% |
| Sample 2 | PURETEMP ® 4 | 53 | −0.02% |

### Advantages

The thermoset thermal energy gel has numerous advantages including that it is shape stable in whatever geometry is desired, even complex 3-D geometries. Further, as a shape stable gel, the composition will not leak if the packaging is punctured. The gel in-place-nature of the radiation curable PCM solution improves coverage/contact between the product to be protected. The gel provides mechanical protection to the product, such as drop, shock, and vibration protection, because of the elastomeric nature of the gel and the gel is soft and conformable (i.e., not rigid). The PCM solution is cheaper to make, includes less ingredients, and cures quickly, and is workable at room temperature. The PCM solution can be cured in-situ, and it is even possible to cure the PCM solution via 3D printing.

With respect to manufacturing, the PCM solution being stable at room temperature makes it easy to handle and the solution can replace existing liquid PCMs in existing manufacturing lines as long as the package, container, or housing receiving the PCM solution is radiation transparent, such that the PCM solution can be cured while therein. For example, if the PCM solution is pumpable to fill sachets or pouches in a sachet filling machine, the manufacturer would only need to add a UV flood cure and/or a UV conveyor system at the end of the existing manufacturing line to make gelled PCM products.

Having described the invention in detail and by reference to specific embodiments and examples, it will be apparent that numerous modifications and variations are possible without departing from the spirit of the invention as defined by the following claims.

What is Claimed is:

What is claimed is:

1. A thermoset thermal energy gel comprising:
a radiation cured polymeric network formed from
a hydrophobic phase change material;
(a) 1% wt/wt to 15% wt/wt of a polybutadiene based rubber polymer that is soluble in the hydrophobic phase change material and has (i) a pendant 1,2 vinyl content of at least 0.5% wt/wt thereof or (ii) a 1,4 cis content of at least 9.0% wt/wt; or (iii) a combination of 1,2 vinyl content plus a 1,4 cis content of at least 45% wt/wt; or
(b) 1% wt/wt to 15% wt/wt of a polyisoprene based rubber polymer that is soluble in the hydrophobic phase change material and has (i) a combination of 1,2 Add plus 3,4 Add content of at least 0.5% wt/wt thereof or (ii) a combination of 1,4 cis content plus a 1,4 trans content of at least 40% wt/wt; and
0.01% wt/wt to 0.50% wt/wt of a photoinitiator soluble in the hydrophobic phase change material;
wherein the hydrophobic phase change material is the balance thereof.

2. The thermoset thermal energy gel of claim 1, wherein the polybutadiene based rubber polymer or the polyisoprene based rubber polymer is present as 1% to 10% wt/wt of the thermoset thermal energy gel.

3. The thermoset thermal energy gel of claim 1, wherein the polybutadiene based rubber polymer is a polybutadiene rubber, a styrene butadiene rubber, or a styrene butadiene styrene rubber.

4. The thermoset thermal energy gel of claim 1, wherein the polybutadiene based rubber polymer is (a) a high vinyl 1,2-polybutadiene atactic linear polymer with a vinyl content of 77%, with a Tg of −31° C. and a Mooney viscosity (ML (1+4), 100° C.) of 70, (b) a high vinyl 1,2-polybutadiene polymer that is syndiotactic, with a Mw of 100,000 g/mol a melting point of 71° C., and a 1,2-polybutadiene vinyl content of 90% wt/wt, or (c) a random copolymer high vinyl solution polymerized styrene butadiene rubber (S-SBR), with a styrene content of 15% to 21% wt/wt, a 1,2-vinyl content of 48% to 68% with respect to polybutadiene, and a Mooney viscosity between 58 and 75.

5. The thermoset thermal energy gel of claim 1, wherein the polyisoprene based rubber polymer is a polyisoprene rubber, a copolymer of polyisoprene and polybutadiene rubber, or a styrene isoprene styrene rubber.

6. The thermoset thermal energy gel of claim 3, wherein the rubber polymer has a dissolution point, in the hydrophobic phase change material, of equal to or less than 100° C.

7. The thermoset thermal energy gel of claim 3, wherein the rubber polymer has a dissolution point in the hydrophobic phase change material, of equal to or less than 75° C.

8. The thermoset thermal energy gel of claim 3, wherein the rubber polymer has a dissolution point, in the hydrophobic phase change material, in a range of 30° C. to 40° C.

9. The thermoset thermal energy gel of claim 3, wherein the rubber polymer is a syndiotactic butadiene rubber.

10. The thermoset thermal energy gel of claim 3, wherein the rubber polymer is a 1,4 cis butadiene rubber having a 1,4 cis content of between 35% to 40% wt/wt.

11. The thermoset thermal energy gel of claim 3, wherein the rubber polymer is a 1,4 cis butadiene rubber having a 1,4 cis content of at least 90% wt/wt.

12. The thermoset thermal energy gel of claim 1, wherein the hydrophobic phase change material is selected from the group consisting of an n-alkane, a fatty acid methyl ester, a fatty alcohol, a fatty acid, and mixtures thereof.

13. The thermoset thermal energy gel of claim 12, wherein the n-alkane is saturated and has carbon atoms within the range of C₁₀-C₃₀ and the fatty acid methyl ester has carbon atoms within the range of C₁₂-C₁₆.

14. The thermoset thermal energy gel of claim 1, wherein the photoinitiator comprises phosphine oxide.

15. The thermoset thermal energy gel of claim 1, comprising a hydrogenated styrenic block copolymer as a secondary resin as 0.5% to 15% wt/wt of the gel.

16. The thermoset thermal energy gel of claim 15, wherein the hydrogenated styrenic block copolymer is fully hydrogenated and is selected from the group consisting of a styrene-ethylene-propylene (SEP) polymer, a styrene-ethylene-propylene-styrene (SEPS) polymer, a styrene-ethylene-ethylene-propylene-styrene (SEEPS) polymer, a styrene-ethylene-butylene-styrene (SEBS) polymer, a SEBS with an enhanced rubber segment (ERS), a styrene-ethylene butylene/styrene-styrene (S-EB/S-S) polymer, and combinations thereof.

17. The thermoset thermal energy gel of claim 15, wherein the hydrogenated styrenic block copolymer is a diblock SEP.

18. The thermoset thermal energy gel of claim 17, wherein the diblock SEP has styrene as 25% to 40% wt/wt thereof and is 100% diblock in structure.

19. The thermoset thermal energy gel of claim 15, wherein the hydrogenated styrenic block copolymer is a diblock or triblock copolymer.

20. A radiation curable phase change solution comprising:
a hydrophobic phase change material;
(a) 1% wt/wt to 15% wt/wt of a polybutadiene based rubber polymer that is soluble in the hydrophobic phase change material and has (i) a pendant 1,2 vinyl content of at least 0.5% wt/wt thereof or (ii) a 1,4 cis content of at least 9.0% wt/wt; or (iii) a combination of 1,2 vinyl content plus a 1,4 cis content of at least 45% wt/wt; or
(b) 1% wt/wt to 15% wt/wt of a polyisoprene based rubber polymer that is soluble in the hydrophobic phase change material and has (i) a combination of 1,2 Add plus 3,4 Add content of at least 0.5% wt/wt thereof or (ii) a combination of 1,4 cis content plus a 1,4 trans content of at least 40% wt/wt; and
0.01% wt/wt to 0.50% wt/wt of a photoinitiator soluble in the hydrophobic phase change material;
wherein the hydrophobic phase change material is the balance thereof, and upon exposure to radiation the composition cures to form a thermoset gel.

21. A cold pack comprising:
a container sealingly enclosing the thermoset gel of claim 1.

22. The cold pack of claim 21, wherein the container is a rigid container that retains a preselected shape and configuration or the container is a flexible container that is conformable to a surface against which the flexible container is seated.
